(19) United States
(12) Patent Application Publication
(10) Pub. No.: US 2024/0404165 A1
(43) Pub. Date: Dec. 5, 2024

(54) Rendering Layers with Different Perception Quality

(71) Applicant: Apple Inc., Cupertino, CA (US)

(72) Inventors: Yashas Rai Kurlethimar, San Jose, CA (US); Jonathan Moorman, San Jose, CA (US); Mark L. Ma, San Francisco, CA (US); Michael E. Buerli, San Francisco, CA (US); Seyedkoosha Mirhosseini, Santa Clara, CA (US); Sushant Ojal, Sunnyvale, CA (US)

(21) Appl. No.: 18/672,922

(22) Filed: May 23, 2024

Related U.S. Application Data
(60) Provisional application No. 63/470,658, filed on Jun. 2, 2023.

(51) Int. Cl. G06T 15/00; G06F 3/01; G06T 5/50

(52) U.S. Cl. CPC G06T 15/00; G06F 3/013; G06T 5/50; G06T 2207/20221

(57) ABSTRACT

In one implementation, a method of displaying image is performed by a device including one or more processors and non-transitory memory. The method includes obtaining gaze information. The method includes obtaining, based on the gaze information, a first resolution function and a second resolution function different than the first resolution function. The method includes rendering a first layer based on first virtual content and the first resolution function. The method includes rendering a second layer based on second virtual content and the second resolution function. The method includes compositing the first layer and the second layer into an image. The method includes displaying, on the display, the image.

### CROSS-REFERENCE TO RELATED APPLICATIONS

This application claims priority to U.S. Provisional Patent App. No. 63/470,658, filed on Jun. 2, 2023, which is hereby incorporated by reference in its entirety.

### TECHNICAL FIELD

The present disclosure generally relates to rendering layers of an image with different perception quality.

### BACKGROUND

Rendering or otherwise processing an image can be computationally expensive. Accordingly, to reduce this computational burden, advantage is taken of the fact that humans typically have relatively weak peripheral vision. Accordingly, different portions of the image are presented on a display panel with different resolutions. For example, in various implementations, portions corresponding to a user's fovea are presented with higher resolution than portions corresponding to a user's periphery.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIG. 2 illustrates an XR pipeline that receives XR content and displays an image on a display panel based on the XR content in accordance with some implementations.

FIGS. 3A-3D illustrate various resolution functions in a first dimension in accordance with various implementations.

FIGS. 4A-4D illustrate various two-dimensional resolution functions in accordance with various implementations.

FIG. 5A illustrates an example resolution function that characterizes a resolution in a display space as a function of angle in a warped space in accordance with some implementations.

FIG. 5B illustrates the integral of the example resolution function of FIG. 5A in accordance with some implementations.

FIG. 5C illustrates the tangent of the inverse of the integral of the example resolution function of FIG. 5A in accordance with some implementations.

FIG. 6A illustrates an example resolution function for performing static foveation in accordance with some implementations.

FIG. 6B illustrates an example resolution function for performing dynamic foveation in accordance with some implementations.

FIG. 7A illustrates an example image representation, in a display space, of XR content to be rendered in accordance with some implementations.

FIG. 7B illustrates a warped image of the XR content of FIG. 8A in accordance with some implementations.

FIG. 8 illustrates an example foreground resolution function for a foreground layer and an example background resolution function for a background layer.

FIG. 9A-9C illustrate an example rendering of a first display image by the XR pipeline of FIG. 2.

FIGS. 10A-10C illustrate an example rendering of a second display image by the XR pipeline of FIG. 2.

FIGS. 11A-11N illustrate an XR environment at a series of times in accordance with some implementations.

FIG. 12A is a flowchart representation of a method of displaying an image in accordance with some implementations.

FIG. 12B is a flowchart representation of a method of displaying a sequence of images in accordance with some implementations.

FIG. 12C is a flowchart representation of a method of unloading an application in accordance with some implementations.

FIG. 13 is a block diagram of an example controller in accordance with some implementations.

FIG. 14 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and method for displaying an image. In various implementations, the method is performed by a device including a display, one or more processors, and non-transitory memory. The method includes obtaining gaze information. The method includes obtaining, based on the gaze information, a first resolution function and a second resolution function different than the first resolution function. The method includes rendering a first layer based on first virtual content and the first resolution function. The method includes rendering a second layer based on second virtual content and the second resolution function. The method includes compositing the first layer and the second layer into an image. The method includes displaying, on the display, the image.

Various implementations disclosed herein include devices, systems, and method for displaying a sequence of images. In various implementations, the method is performed by a device including a display, one or more processors, and non-transitory memory. The method includes rendering a first layer for a first display time based on first virtual content. The method includes rendering a second layer for the first display time based on second virtual content. The method includes compositing the first layer and the second layer into a first image. The method includes displaying, on the display at the first display time, the first image. The method includes rendering a third layer for a second display time based on third virtual content. The method includes extrapolating a fourth layer for the second display time based on the second layer and a predicted pose of the device at the second display time. The method includes compositing the third layer and the fourth layer into a second image. The method includes displaying, on the display at the second display time, the second image.

Various implementations disclosed herein include devices, systems, and method for unloading an application. In various implementations, the method is performed by a device including a display, one or more processors, and non-transitory memory. The method includes loading, into the non-transitory memory, an application. The method includes executing, using the one or more processors, the application to display, on the display at a location in a volumetric environment, a virtual object. The method includes detecting an unloading trigger. The method includes, in response to detecting the unloading trigger, storing, in the non-transitory memory, a snapshot of the virtual object. The method includes, in response to detecting the unloading trigger, storing, in the non-transitory memory, the location in the volumetric environment. The method includes, in response to detecting the unloading trigger, unloading, from the non-transitory memory, the application. The method includes, while the application is unloaded from the non-transitory memory, displaying the snapshot at the location in the volumetric environment.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

As noted above, in various implementations, different portions of an image are presented on a display panel with different resolutions. In various implementations, an image is rendered as a plurality of layers. For example, the image is rendered as a foreground layer laid over a background layer. In various implementations, the resolutions at corresponding locations of the foreground layer and the background layer may differ. Further, in various implementations, the foreground layer and the background layer may be rendered at different rendering frame rates and extrapolated to the same display frame rate.

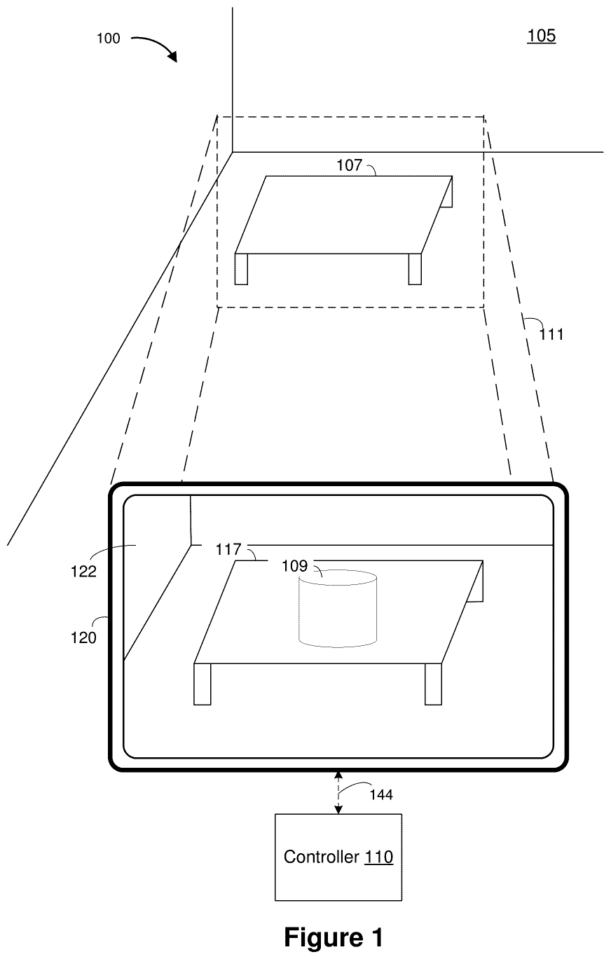

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

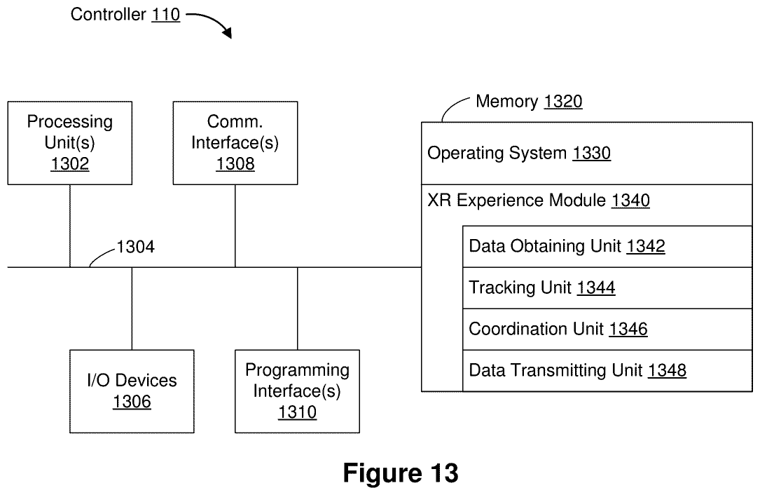

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 13. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

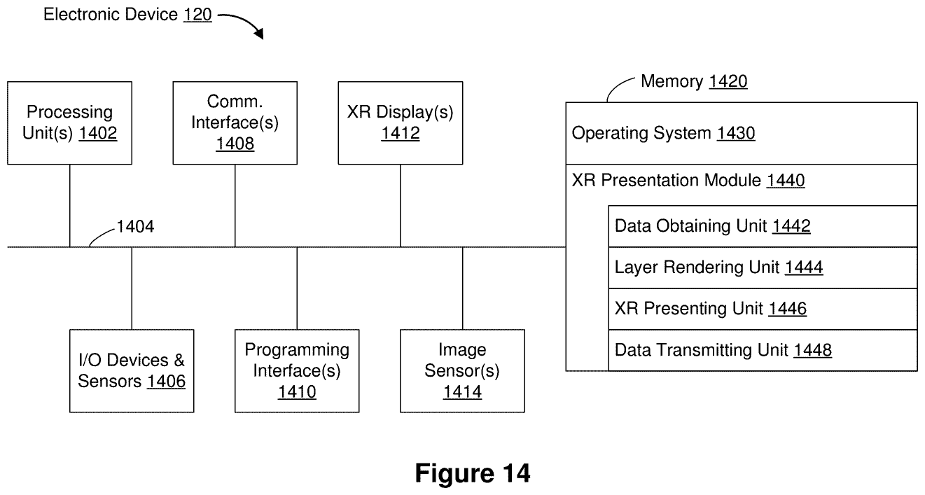

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 14.

According to some implementations, the electronic device 120 provides an XR experience to the user while the user is virtually and/or physically present within the physical environment 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

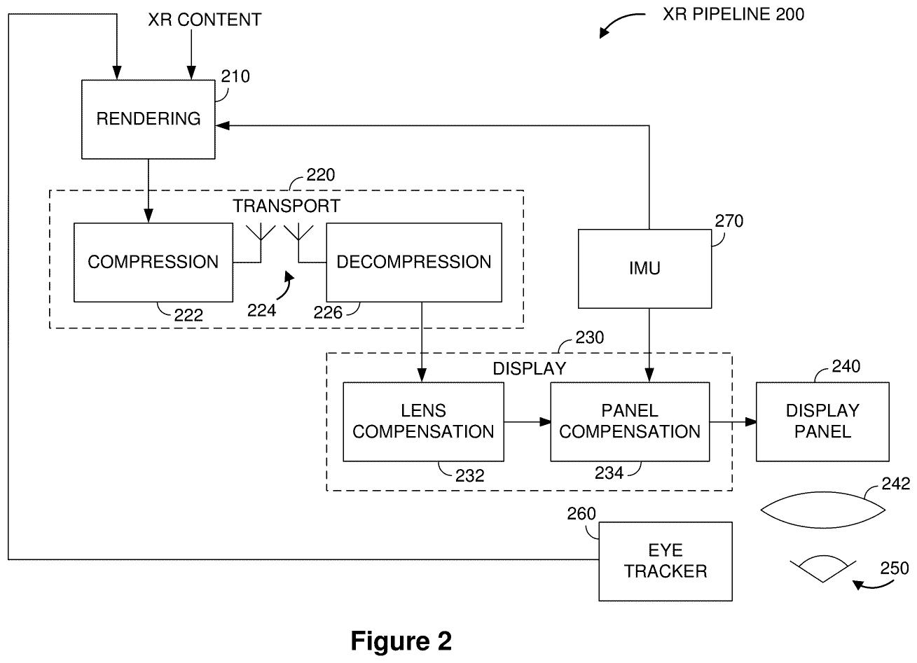

In various implementations, the electronic device 120 includes an XR pipeline that presents the XR content. FIG. 2 illustrates an XR pipeline 200 that receives XR content and displays an image on a display panel 240 based on the XR content.

The XR pipeline 200 includes a rendering module 210 that receives the XR content (and eye tracking data from an eye tracker 260) and renders an image based on the XR content. In various implementations, XR content includes definitions of geometric shapes of virtual objects, colors and/or textures of virtual objects, images (such as a pass-through image of the physical environment), and other information describing content to be represented in the rendered image.

An image includes a matrix of pixels, each pixel having a corresponding pixel value and a corresponding pixel location. In various implementations, the pixel values range from 0 to 255. In various implementations, each pixel value is a color triplet including three values corresponding to three color channels. For example, in one implementation, an image is an RGB image and each pixel value includes a red value, a green value, and a blue value. As another example, in one implementation, an image is a YUV image and each pixel value includes a luminance value and two chroma values. In various implementations, the image is a YUV444 image in which each chroma value is associated with one pixel. In various implementations, the image is a YUV420 image in which each chroma value is associated with a 2×2 block of pixels (e.g., the chroma values are downsampled). In some implementations, an image includes a matrix of tiles, each tile having a corresponding tile location and including a block of pixels with corresponding pixel values. In some implementations, each tile is a 32×32 block of pixels. While specific pixel values, image formats, and tile sizes are provided, it should be appreciated that other values, formats, and tile sizes may be used.

The image rendered by the rendering module 210 (e.g., the rendered image) is provided to a transport module 220 that couples the rendering module 210 to a display module 230. The transport module 220 includes a compression module 222 that compresses the rendered image (resulting in a compressed image), a communications channel 224 that carries the compressed image, and a decompression module 226 that decompresses the compressed image (resulting in a decompressed image).

The decompressed image is provided to a display module 230 that converts the decompressed image into panel data. The panel data is provided to a display panel 240 that displays a displayed image as described by (e.g., according to) the panel data. The display module 230 includes a lens compensation module 232 that compensates for distortion caused by an eyepiece 242 of the electronic device 120. For example, in various implementations, the lens compensation module 232 pre-distorts the decompressed image in an inverse relationship to the distortion caused by the eyepiece 242 such that the displayed image, when viewed through the eyepiece 242 by a user 250, appears undistorted. The display module 230 also includes a panel compensation module 234 that converts image data into panel data to be read by the display panel 240.

The display panel 240 includes a matrix of M×N pixels located at respective locations in a display space. The display panel 240 displays the displayed image by emitting light from each of the pixels as described by (e.g., according to) the panel data.

In various implementations, the XR pipeline 200 includes an eye tracker 260 that generates eye tracking data indicative of a gaze of the user 250. In various implementations, the eye tracking data includes data indicative of a fixation point of the user 250 on the display panel 240. In various implementations, the eye tracking data includes data indicative of a gaze angle of the user 250, such as the angle between the current optical axis of the user 250 and the optical axis when the user 250 is looking at the center of the display panel 240.

In various implementations, the XR pipeline 200 includes an inertial measurement unit (IMU) 270 that generates pose data indicative of a pose (e.g., a location and/or orientation) of device including the XR pipeline 200 and/or indicative of a change in the pose of the device. In various implementations, the rendering module 210 generates the rendered image based on the pose data (e.g., a predicted pose of the device at a display time of the displayed image). In various implementations, the panel compensation module 234 generates the panel data based on the pose data (e.g., an updated predicted pose of the device at the display time of the displayed image).

In various implementations, in order to render an image for display on the display panel 240, the rendering module 210 generates M×N pixel values for each pixel of an M×N image. Thus, each pixel of the rendered image corresponds to a pixel of the display panel 240 with a corresponding location in the display space. Thus, the rendering module 210 generates a pixel value for M×N pixel locations uniformly spaced in a grid pattern in the display space.

Rendering M×N pixel values can be computationally expensive. Further, as the size of the rendered image increases, so does the amount of processing needed to compress the image at the compression module 222, the amount of bandwidth needed to transport the compressed image across the communications channel 224, and the amount of processing needed to decompress the compressed image at the decompression module 226.

In various implementations, in order to decrease the size of the rendered image without degrading the user experience, foveation (e.g., foveated imaging) is used. Foveation is a digital image processing technique in which the image resolution, or amount of detail, varies across an image. Thus, a foveated image has different resolutions at different parts of the image. Humans typically have relatively weak peripheral vision. According to one model, resolvable resolution for a user is maximum over a fovea (e.g., an area where the user is gazing) and falls off in an inverse linear fashion. Accordingly, in one implementation, the displayed image displayed by the display panel 240 is a foveated image having a maximum resolution at a fovea and a resolution that decreases in an inverse linear fashion in proportion to the distance from the fovea.

Because some portions of the image have a lower resolution, an M×N foveated image includes less information than an M×N unfoveated image. Thus, in various implementations, the rendering module 210 generates, as a rendered image, a foveated image. The rendering module 210 can generate an M×N foveated image more quickly and with less processing power (and battery power) than the rendering module 210 can generate an M×N unfoveated image. Also, an M×N foveated image can be expressed with less data than an M×N unfoveated image. In other words, an M×N foveated image file is smaller in size than an M×N unfoveated image file. In various implementations, compressing an M×N foveated image using various compression techniques results in fewer bits than compressing an M×N unfoveated image.

A foveation ratio, R, can be defined as the amount of information in the M×N unfoveated image divided by the amount of information in the M×N foveated image. In various implementations, the foveation ratio is between 1.5 and 10. For example, in some implementations, the foveation ratio is 2. In some implementations, the foveation ratio is 3 or 4. In some implementations, the foveation ratio is constant among images. In some implementations, the foveation ratio is determined for the image being rendered. For example, in various implementations, the amount of information the XR pipeline 200 is able to throughput within a particular time period, e.g., a frame period of the image, may be limited. For example, in various implementations, the amount of information the rendering module 210 is able to render in a frame period may decrease due to a thermal event (e.g., when processing to compute additional pixel values would cause a processor to overheat). As another example, in various implementations, the amount of information the transport module 220 is able to transport in a frame period may decrease due to a decrease in the signal-to-noise ratio of the communications channel 224.

In some implementations, in order to render an image for display on the display panel 240, the rendering module 210 generates M/R×N/R pixel values for each pixel of an M/R×N/R warped image. A pixel of the warped image corresponds to an area greater than a pixel of the display panel 240 at a corresponding location in the display space. Thus, the rendering module 210 generates a pixel value for each of M/R×N/R locations in the display space that are not uniformly distributed in a grid pattern. The respective area in the display space corresponding to each pixel value is defined by the corresponding location in the display space (a rendering location) and a scaling factor (which may be a single value for both a horizontal scaling and a vertical scaling or a doublet of values including a horizontal scaling factor value for horizontal scaling and a vertical scaling factor value for vertical scaling).

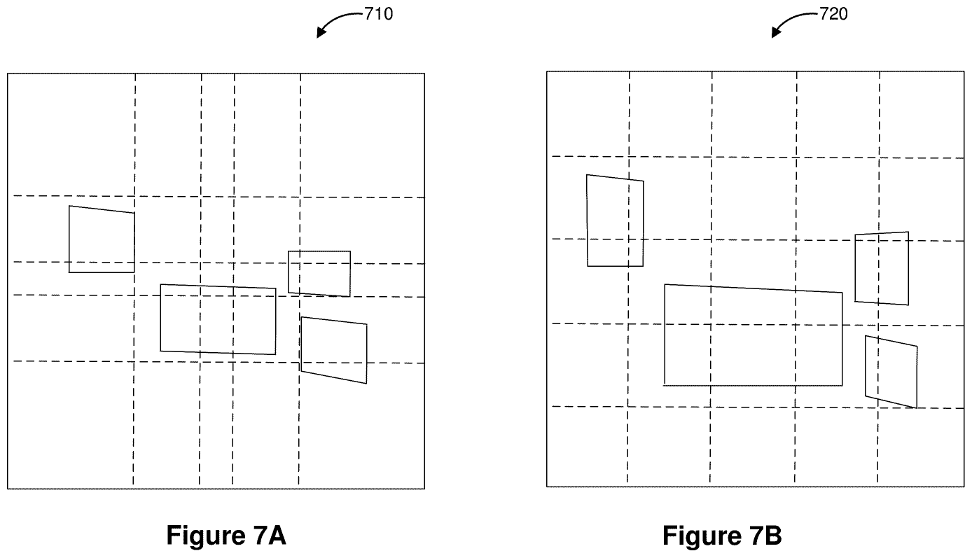

In various implementations, the rendering module 210 generates, as a rendered image, a warped image. In various implementations, the warped image includes a matrix of M/R×N/R pixel values for M/R×N/R locations uniformly spaced in a grid pattern in a warped space that is different than the display space. Particularly, the warped image includes a matrix of M/R×N/R pixel values for M/R×N/R locations in the display space that are not uniformly distributed in a grid pattern. Thus, whereas the resolution of the warped image is uniform in the warped space, the resolution varies in the display space. This is described in greater detail below with respect to FIGS. 7A and 7B.

The rendering module 210 determines the rendering locations and the corresponding scaling factors based on a resolution function that generally characterizes the resolution of the rendered image in the displayed space.

In one implementation, the resolution function, S(x), is a function of a distance from an origin of the display space (which may correspond to the center of the display panel 240). In another implementation, the resolution function, S(θ), is a function of an angle between an optical axis of the user 250 and the optical axis when the user 250 is looking at the center of the display panel 240. Thus, in one implementation, the resolution function, S(θ), is expressed in pixels per degree (PPD).

Humans typically have relatively weak peripheral vision. According to one model, resolvable resolution for a user is maximum over a fovea and falls off in an inverse linear fashion as the angle increases from the optical axis. Accordingly, in one implementation, the resolution function (in a first dimension) is defined as:

$$S ( θ ) = \{ \begin{matrix}{S}_{max} & for \vert θ \vert < {θ}_{f} \\ {S}_{min} + \frac{{S}_{max} - {S}_{min}}{1 + w ( \vert θ - {θ}_{f} \vert )} & for \vert θ \vert \geq {θ}_{f}\end{matrix} ,$$

where Sₘₐₓ is the maximum of the resolution function (e.g., approximately 60 PPD), Sₘᵢₙ is the asymptote of the resolution function, θ_{f} characterizes the size of the fovea, and w characterizes a width of the resolution function or how quickly the resolution function falls off outside the fovea as the angle increases from the optical axis.

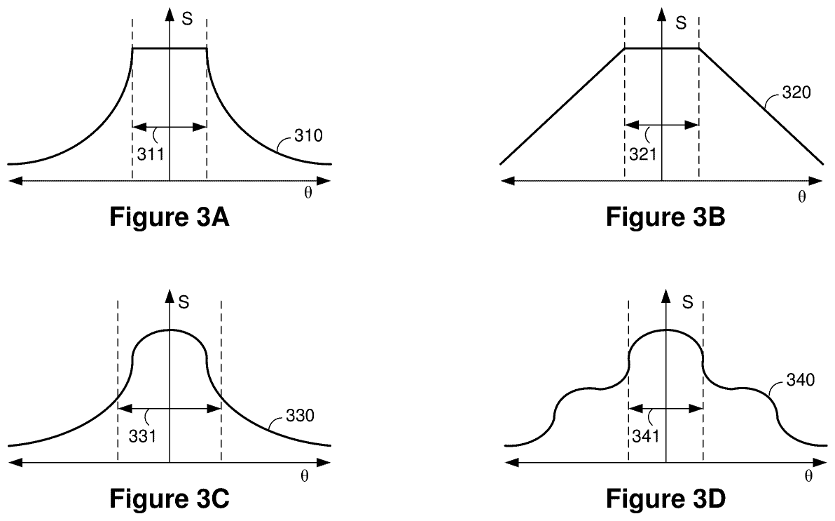

FIG. 3A illustrates a resolution function 310 (in a first dimension) which falls off in an inverse linear fashion from a fovea. FIG. 3B illustrates a resolution function 320 (in a first dimension) which falls off in a linear fashion from a fovea. FIG. 3C illustrates a resolution function 330 (in a first dimension) which is approximately Gaussian. FIG. 3D illustrates a resolution function 340 (in a first dimension) which falls off in a rounded stepwise fashion.

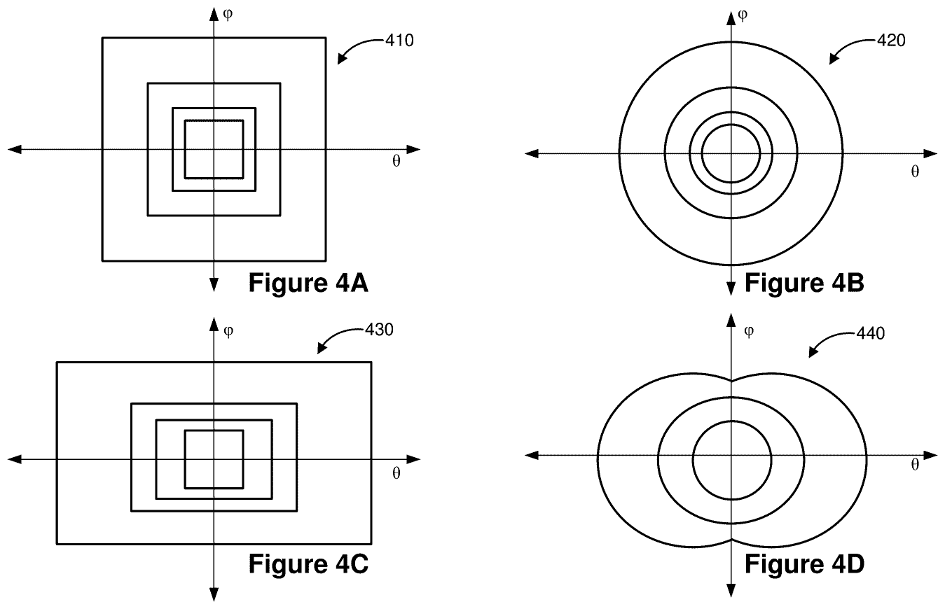

Each of the resolution functions 310-340 of FIGS. 3A-3D is in the form of a peak including a peak height (e.g., a maximum value) and a peak width. The peak width can be defined in a number of ways. In one implementation, the peak width is defined as the size of the fovea (as illustrated by width 311 of FIG. 3A and width 321 of FIG. 3B). In one implementation, the peak width is defined as the full width at half maximum (as illustrated by width 331 of FIG. 3C). In one implementation, the peak width is defined as the distance between the two inflection points nearest the origin (as illustrated by width 341 of FIG. 3D). In various implementations, the number of pixels in a rendered image is proportional to the integral of the resolution function over the field-of-view. Thus, a summation value is defined as the area under the resolution function over the field-of-view.

Whereas FIGS. 3A-3D illustrate resolution functions in a single dimension, it is to be appreciated that the resolution function used by the rendering module 210 can be a two-dimensional function. FIG. 4A illustrates a two-dimensional resolution function 410 in which the resolution function 410 is independent in a horizontal dimension (θ) and a vertical dimension (φ). FIG. 4B illustrates a two-dimensional resolution function 420 in which the resolution function 420 is a function of a single variable (e.g., D=\sqrt{θ²+φ²}). FIG. 4C illustrates a two-dimensional resolution function 430 in which the resolution function 430 is different in a horizontal dimension (θ) and a vertical dimension (φ). FIG. 4D illustrates a two-dimensional resolution function 440 based on a human vision model.

As described in detail below, the rendering module 210 generates the resolution function based on a number of factors, including biological information regarding human vision, eye tracking data, eye tracking metadata, the XR content, and various constraints (such as constraints imposed by the hardware of the electronic device 120).

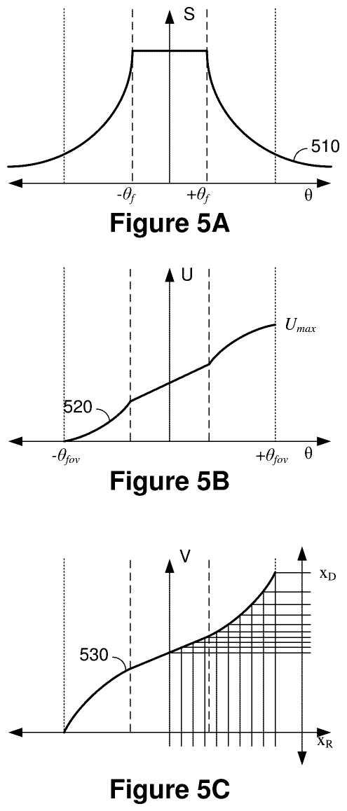

FIG. 5A illustrates an example resolution function 510, denoted S(θ), which characterizes a resolution in the display space as a function of angle in the warped space. The resolution function 510 is a constant (e.g., Sₘₐₓ) within a fovea (between −θ_{f} and +θ_{f}) and falls off in an inverse linear fashion outside this window.

FIG. 5B illustrates the integral 520, denoted U(θ), of the resolution function 510 of FIG. 5A within a field-of-view, e.g., from −θ_{f} or to +0 for. Thus,

$$U ( θ ) = {\int }_{- {θ}_{fov}}^{θ} S ( \check{θ} ) d \check{θ} .$$

The integral 520 ranges from 0 at −θ_{f} or to a maximum value, denoted Uₘₐₓ, at +θ_{fov}.

FIG. 5C illustrates the tangent 530, denoted V (x_{R}), of the inverse of the integral 520 of the resolution function 510 of FIG. 5A. Thus, V (x_{R})=tan(U⁻¹(x_{R})). The tangent 530 illustrates a direct mapping from rendered space, in x_{R}, to display space, in x_{D}. According to the foveation indicated by the resolution function 510, the uniform sampling points in the warped space (equally spaced along the x_{R} axis) correspond to non-uniform sampling points in the display space (non-equally spaced along the x_{D} axis). Scaling factors can be determined by the distances between the non-uniform sampling points in the display space.

When performing static foveation, the rendering module 210 uses a resolution function that does not depend on the gaze on the user. However, when performing dynamic foveation, the rendering module 210 uses a resolution function that depends on the gaze of the user. In particular, when performing dynamic foveation, the rendering module 210 uses a resolution function that has a peak height at a location corresponding to a location in the display space at which the user is looking (e.g., a gaze point of the user as determined by the eye tracker 260).

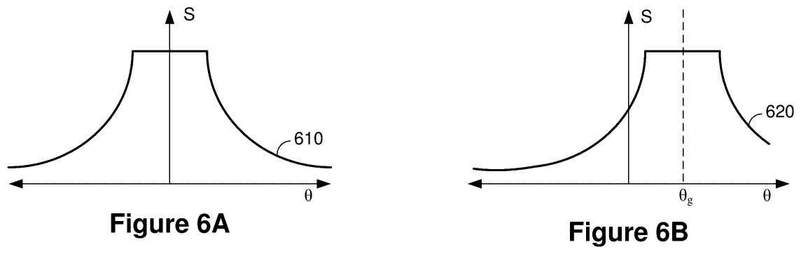

FIG. 6A illustrates a resolution function 610 that may be used by the rendering module 210 when performing static foveation. The rendering module 210 may also use the resolution function 610 of FIG. 6A when performing dynamic foveation and the user is looking at the center of the display panel 240. FIG. 6B illustrates a resolution function 620 that may be used by the rendering module 210 when performing dynamic foveation and the user is looking at a gaze angle (θ_{g}) away from the center of the display panel 240.

Accordingly, in one implementation, the resolution function (in a first dimension) is defined as:

$$S ( θ ) = \{ \begin{matrix}{S}_{max} & for \vert θ - {θ}_{g} \vert < {θ}_{f} \\ {S}_{min} + \frac{{S}_{max} - {S}_{min}}{1 + w ( \vert θ - {θ}_{g} - {θ}_{f} \vert )} & for \vert θ - {θ}_{g} \vert \geq {θ}_{f}\end{matrix} .$$

An image that is said to be in a display space has uniformly spaced regions (e.g., pixels or groups of pixels) that map to uniformly spaced regions (e.g., pixels or groups of pixels) of a display. An image that is said to be in a warped space has uniformly spaced regions (e.g., pixels or groups of pixels) that map to non-uniformly spaced regions (e.g., pixels or groups of pixels) in the display space. The relationship between uniformly spaced regions in the warped space to non-uniformly spaced regions in the display space is defined at least in part by the scaling factors. Thus, the plurality of respective scaling factors (like the resolution function) defines a mapping between the warped space and the display space.

In various implementations, the rendering module transmits the warped image including the plurality of pixel values in association with the plurality of respective scaling factors. In various implementations, the plurality of respective scaling factors is transmitted as a matrix having the same size as the warped image, e.g., as an M/R×N/R scaling factor matrix. Accordingly, the warped image and the scaling factor matrix, rather than a foveated image which could be generated using this information, is propagated through the XR pipeline 200.

In particular, with respect to FIG. 2, in various implementations, the rendering module 210 generates a warped image and a scaling factor matrix that are transmitted by the rendering module 210. At various stages in the XR pipeline 200, the warped image (or a processed version of the warped image) and the scaling factor matrix are received (and used in processing the warped image) by the transport module 220 (and the compression module 222 and decompression module 226 thereof). At various stages in the XR pipeline 200, the warped image (or a processed version of the warped image) and the scaling factor matrix are received (and used in processing the warped image) by the display module 230 (and the lens compensation module 232 and the panel compensation module 234 thereof).

In various implementations, the rendering module 210 generates the scaling factor matrix based on the resolution function. For example, in some implementations, the scaling factor matrix is generated based on the resolution function as described above with respect to FIGS. 5A-5C. In various implementations, generating the scaling factor matrix includes determining the integral of the resolution function. In various implementations, generating the scaling factor matrix includes determining the tangent of the inverse of the integral of the resolution function. In various implementations, generating the scaling factor matrix includes, determining, for each of the respective locations uniformly spaced in a grid pattern in the warped space, the respective scaling factor based on the tangent of the inverse of the integral of the resolution function. Accordingly, for a plurality of locations uniformly spaced in the warped space, a plurality of locations non-uniformly spaced in the display space are represented by the scaling factor matrix.

FIG. 7A illustrates an image representation of XR content 710 to be rendered in a display space. FIG. 7B illustrates a warped image 720 generated using a resolution function. In accordance with the resolution function, different parts of the XR content 710 corresponding to non-uniformly spaced regions (e.g., different amounts of area) in the display space are rendered into uniformly spaced regions (e.g., the same amount of area) in the warped image 720.

For example, the area at the center of the image representation of XR content 710 of FIG. 7A is represented by an area in the warped image 720 of FIG. 7B including K pixels (and K pixel values). Similarly, the area on the corner of the image representation of XR content 710 of FIG. 7A (a larger area than the area at the center of FIG. 7A) is also represented by an area in the warped image 720 of FIG. 7B including K pixels (and K pixel values).

In various implementations the rendering module 210 generates a plurality of layers. Each of the plurality of layers is itself an image, e.g., a matrix of pixel values. Further, each of the plurality of layers is associated with a scaling factor matrix of the same size. For example, in various implementations, the rendering module 210 generates a foreground layer associated with a foreground scaling factor matrix and a background layer associated with a background scaling factor matrix. Each layer and scaling factor matrix is transmitted by the rendering module 210 through the XR pipeline 200. At the panel compensation module 230, the layers are composited to generate panel data provided to the display panel 240.

In various implementations, the panel data includes M×N pixels. For example, in various implementations, the panel data includes an unwarped (but foveated) image. However, in various implementations, the panel data includes less than M×N pixels. In various implementations, the panel data includes a warped (and foveated) image. In various implementations, the panel compensation module 230 transforms the composited layers from the warped space to an intermediate space and the display panel 240 itself transforms the composited layers from the intermediate space to the display space.

In various implementations, the foreground scaling factor matrix is generated based on a foreground resolution function and the background scaling factor matrix is generated with a background resolution function. In various implementations, the foreground resolution function and the background resolution function are different. For example, in various implementations, the foreground resolution function and the background resolution have different maximum resolution.

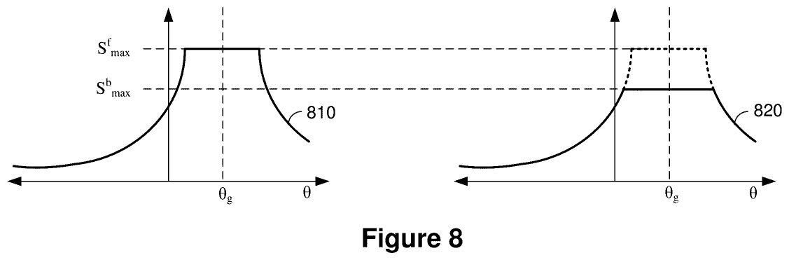

FIG. 8 illustrates an example foreground resolution function 810 for a foreground layer and an example background resolution function 820 for a background layer. The example foreground resolution function has a foreground maximum of S^{f}ₘₐₓ. Further, the example background resolution function has a background maximum of S^{b}ₘₐₓ, which is less than the foreground maximum. In various implementations, the example background resolution function 820 is a capped version of the example foreground resolution function 810 in which the background resolution function 820 is, at each angle, equal to lesser of the foreground resolution function 810 at the angle and the background maximum.

In various implementations, the foreground resolution function and the background resolution are determined using the same formula (e.g., the formula disclosed above), but with different parameters. In various implementations, the background resolution function has a lower maximum than the foreground resolution function (as shown in FIG. 8). In various implementations, the background resolution function has a lower asymptote (or minimum) than the foreground resolution function. In various implementations, the background resolution function has a lower fovea size (or width) than the foreground resolution function. In various implementations, the background resolution function has a faster falloff than the foreground resolution function.

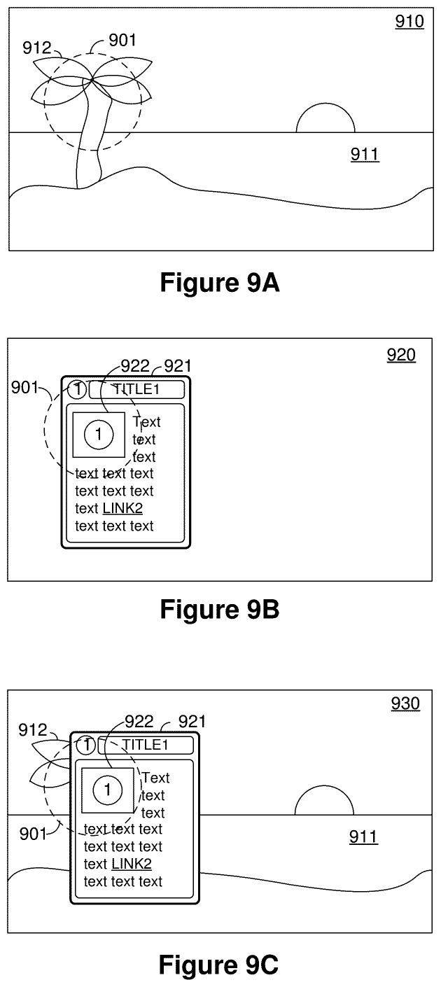

FIG. 9A-9C illustrate an example rendering of a first display image 930 by the XR pipeline 200 of FIG. 2. FIG. 9A illustrates first background XR content 910 received by the rendering module 210. The first background XR content 910 includes a virtual environment. The virtual environment includes a virtual ocean 911 and a virtual tree 912. FIG. 9A also illustrates a fovea 901 (which is not part of the background XR content 910) as determined by the rendering module 210 based on eye tracking data received from the eye tracker 260. FIG. 9B illustrates first foreground XR content 920 received by the rendering module 210. The first foreground XR content 910 includes a virtual window 921 of a web browsing application. Within the virtual window 921 is the first frame of a video 922. FIG. 9B also illustrates the fovea 901 (which is not part of the foreground XR content 920).

The rendering module 210 generates a first background layer and a corresponding first background scaling factor matrix based on the first background XR content 910 and a first background resolution function. The rendering module 210 further generates a first foreground layer and a corresponding first foreground scaling factor matrix based on the first foreground XR content 920 and a first foreground resolution function.

FIG. 9C illustrates the first display image 930 displayed by the display panel 240. FIG. 9C also illustrates the fovea 901 (which is not part of the first display image 930). The rendering module 210 transmits both layers and scaling factor matrices through the XR pipeline 200 to the panel compensation module 234. The panel compensation module 234 generates panel data by compositing the first foreground layer and the first background layer (after processing each layer according to the corresponding scaling factor matrix). The display panel 240 receives the panel data and displays the first display image 930 according to the panel data.

In various implementations, the background resolution function has a lower maximum than the foreground resolution function. Thus, in the first display image 930, even within the fovea 901, the portions of the first display image 930 corresponding to the background XR content 910 have a lower resolution than portions of the first display image 930 corresponding to the foreground XR content 920. For example, in the first display image 930, the leaves of the virtual tree 912 within the fovea 901 have a lower resolution than the video 922.

In addition or as an alternative to rendering a foreground layer and a background layer with different resolution functions, in various implementations, the rendering module 210 renders the foreground layer and the background layer at different rendering frame rates. For example, in various implementations, the rendering module 210 renders the foreground layer based on foreground XR content at a foreground rendering frame rate (e.g., 60 frames per second) and renders the background layer based on background XR content at a background rendering frame rate (e.g., 30 frames per second) which is less than the foreground rendering frame rate. In various implementations, the panel compensation module 234 extrapolates the background layer to the foreground rendering frame rate (or extrapolates both the background layer and the foreground layer to a common display frame rate).

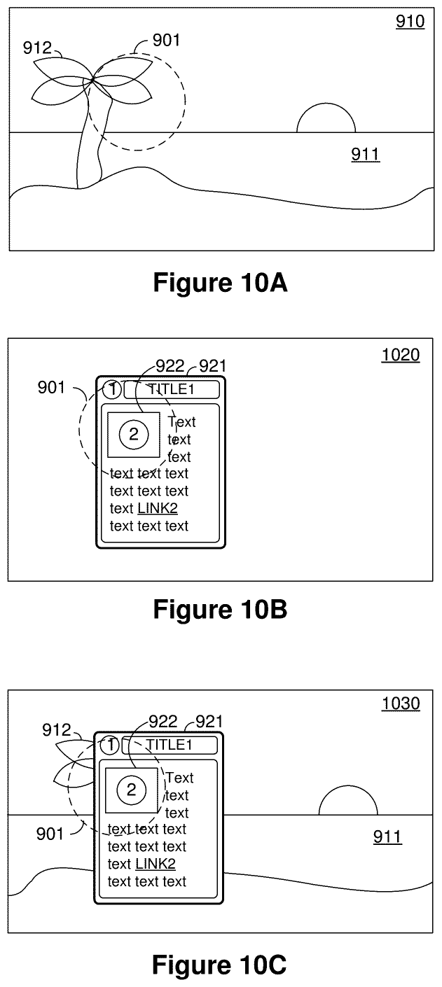

FIGS. 10A-10C illustrate an example rendering of a second display image 1030 by the XR pipeline 200 of FIG. 2. FIG. 10A illustrates the first background XR content 910 previously received by the rendering module 210. FIG. 10A also illustrates the fovea 901 (which is not part of the first background XR content 910) as determined by the rendering module 210 based on eye tracking data received from the eye tracker 260. Between display of the first display image 930 and the second display image 1030, the user has moved to the left but maintained gaze at the same world location. Thus, the fovea 901 is moved to the right in FIGS. 10A-10C as compared to the fovea 901 in FIGS. 9A-9C. FIG. 10B illustrates second foreground XR content 1020 received by the rendering module 210. The second foreground XR content 1020 includes the virtual window 921 with the second frame of the video 922. FIG. 10B also illustrates the fovea 901 (which is not part of the second foreground XR content).

The rendering module 210 generates a second foreground layer and a corresponding second foreground scaling factor matrix based on the second foreground XR content 920 and a second foreground resolution function. In particular, the second foreground resolution function differs from the first foreground resolution function because the fovea 901 has moved to the right. Further, because the user has moved to the left, the rendering module 210 renders the virtual window 921 to the right in the second foreground layer. The rendering module 210 does not generate a second background layer.

FIG. 10C illustrates the second display image 1030 displayed by the display panel 240. FIG. 10C also illustrates the fovea 901 (which is not part of the second display image 1030). The rendering module 210 transmits the second foreground layer and the second scaling factor matrix through the XR pipeline 200 to the panel compensation module 234. The panel compensation model 234 generates an extrapolated first background layer by extrapolating the first background layer using pose data from the IMU 270 indicating that the user has moved (to the left). The panel compensation module 234 generates panel data by compositing the second foreground layer and an extrapolated first background layer (after processing each layer according to the corresponding scaling factor matrix). The display panel 240 receives the panel data and displays the second display image 1030 according to the panel data.

In various implementations, the panel compensation module 234 generates the extrapolated first background layer using a homographic transformation of the first background layer based on depth. In various implementations, forward extrapolation is used in which, for each pixel of the first background layer at a pixel location, a new pixel location for the pixel in the first extrapolated background layer is determined. As another example, in various implementations, backward extrapolation is used in which, for each pixel of the extrapolated first background layer at a pixel location, a corresponding pixel location for the pixel in the first background layer is determined. In various implementations, the homographic transformation is a planar homography (using a constant depth), per-pixel homography (using a variable depth), or a combination of the two at different portions of the first background layer.

Thus, in the second display image 1030, the second frame of the video 922 is displayed, but the virtual environment remains unchanged (but is still transformed such that the virtual window 921 overlays the same portion of the virtual tree 912). In various implementations, the display panel 240 displays a third display image based on second background XR content and third XR foreground content. In the second background XR content, the virtual ocean 911 has rippled and the leaves on the virtual tree 912 have swayed. In the third foreground XR content, the virtual window 921 includes the third frame of the video 922. Thus, whereas the video (in the foreground XR content) is animated at a first frame rate, the virtual environment (in the background XR content) is animated a second frame rate lower than the first frame rate. However, both the foreground XR content and background XR content are displayed at the same display rate, including extrapolation of the background XR content based on motion of the device.

In various implementations, in order to provide for a three-dimensional XR experience, the display panel 240 includes a first portion for displaying a left displayed image to a left eye of the user 250 and a second portion for simultaneously displaying a right displayed image to a right eye of the user 250. Accordingly, in various implementations, the rendering module 210 renders a left foreground layer, a right foreground layer, a left background layer, and a right background layer. Each layer is rendered according to a corresponding resolution function. Each of the corresponding resolution functions may be the same or different.

For example, in various implementations, the left foreground resolution function and the right foreground resolution function are a common foreground resolution function and the left background resolution function and the right background resolution function are a common background resolution function. As described above, in various implementations, the common foreground resolution function and the common background resolution function may be different. For example, in various implementations, the common background resolution function may have a lower maximum than the common foreground resolution function.

As another example, in various implementations, the left foreground resolution function and the right foreground resolution function are different. For example, in various implementations, the left foreground resolution function has a lower maximum than the right resolution function to reduce computation in rendering the first foreground layer and the second foreground layer while minimally reducing the viewing experience due to binocular suppression. Binocular suppression is a visual phenomenon by which the perceived quality of two simultaneously presented images is not reduced when one of the images is of lesser quality, e.g., the lesser quality of the image is suppressed.

Similarly, in various implementations, the left background resolution function and the right background resolution function are different. In various implementations, the difference between the two maxima of the background resolution functions is different (e.g., greater) than the difference between the two maxima of the foreground resolution functions. Thus, in various implementations, higher binocular suppression is expected in the background layer.

In various implementations, the maxima of the left foreground resolution function and the right foreground resolution function are the same, whereas the maxima of the left background resolution function and the right background resolution function are different. Thus, in various implementations, binocular suppression is only expected in the background layer.

In various implementations, the left foreground resolution function has a higher maximum than the right foreground resolution function and, similarly, the left background resolution has a higher maximum than the left foreground resolution function. Thus, binocular suppression in both the foreground layer and the background layer is assigned to the same eye.

In various implementations, in addition or as an alternative to rendering with different resolutions, frame rate, and/or binocular variance, in various implementations, an anti-aliasing algorithm applied to one layer is more computationally intensive than that applied (if one is applied at all) to another layer. As another example, in various implementations, a blurring algorithm (e.g., for depth effects) applied to one layer is stronger than that applied (if one is applied at all) to another layer.

As described above, different layers of a display image are rendered according to different parameters, which may include resolution, frame rate, binocular variance, aliasing, blurring, color gamut, brightness, contrast, saturation, field-of-view, or any other factor affecting computational cost and/or perception quality.

By rendering different layers of the display image with different parameters, power saving via reduced computation is achieved while minimally reducing the viewing experience due to binocular suppression. Another method of reducing computation is to effectively reduce the frame rate of a layer to zero in certain circumstances.

For example, when the virtual objects of an application are outside of a field-of-view of a user, the virtual object may cease to be updated by the application. Because the texture of the virtual object is not being updated by the application, the texture of the virtual object can be replaced by a snapshot of the virtual object and the application can be unloaded from memory for further power savings.

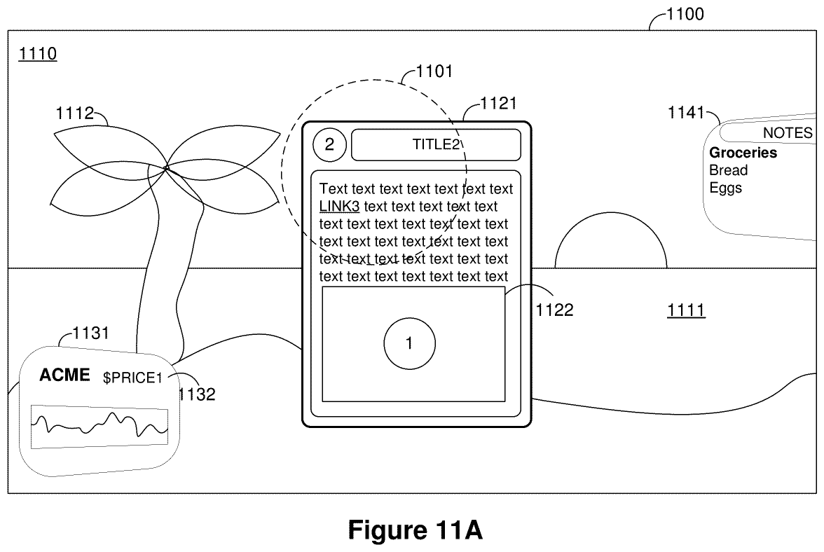

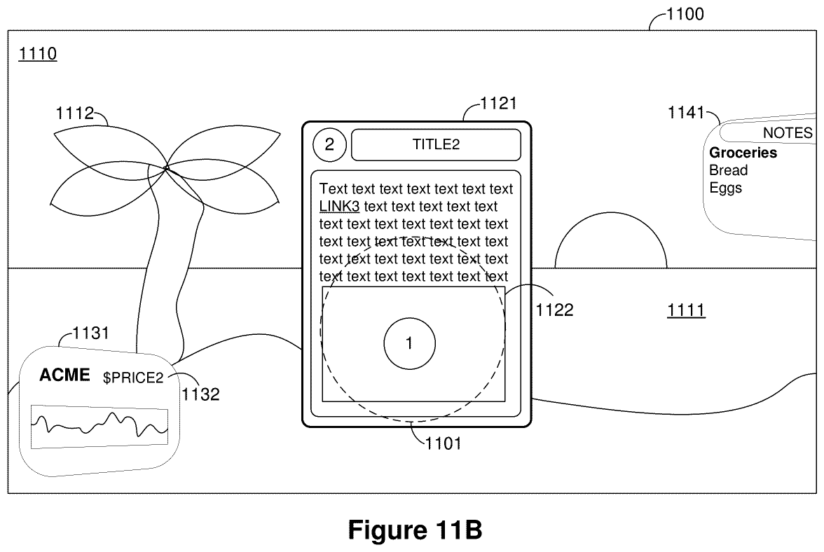

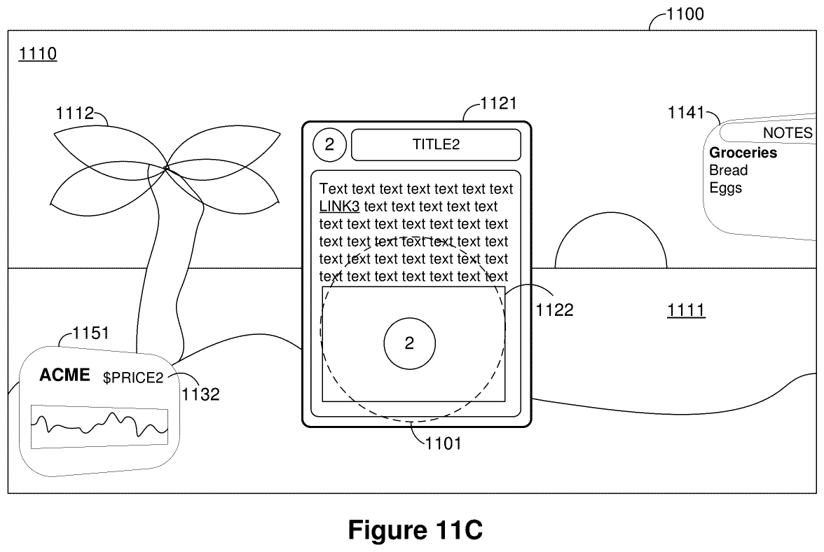

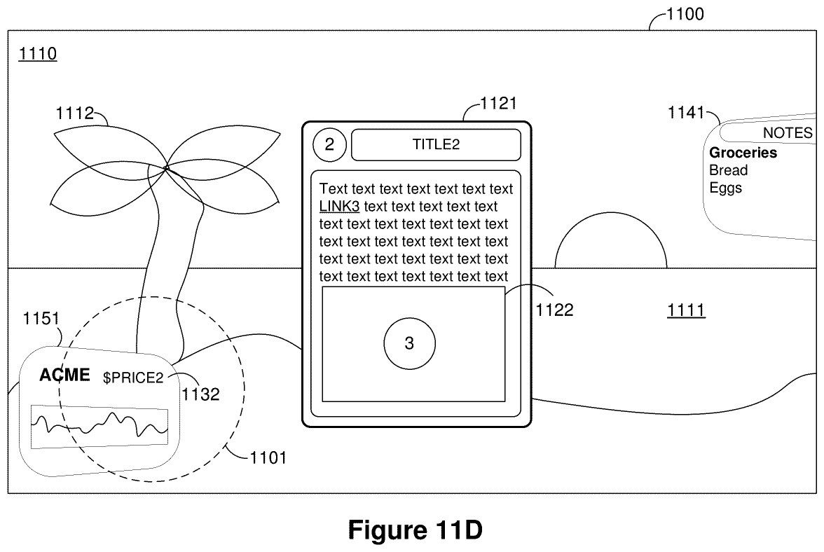

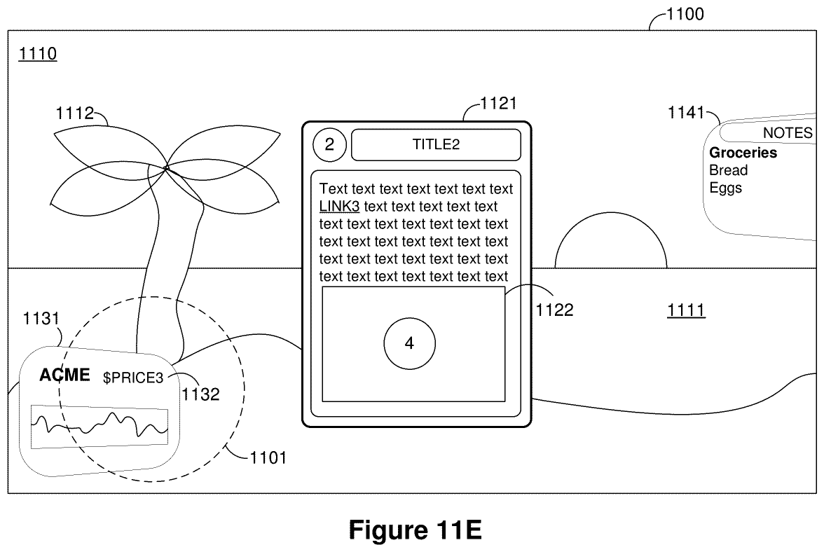

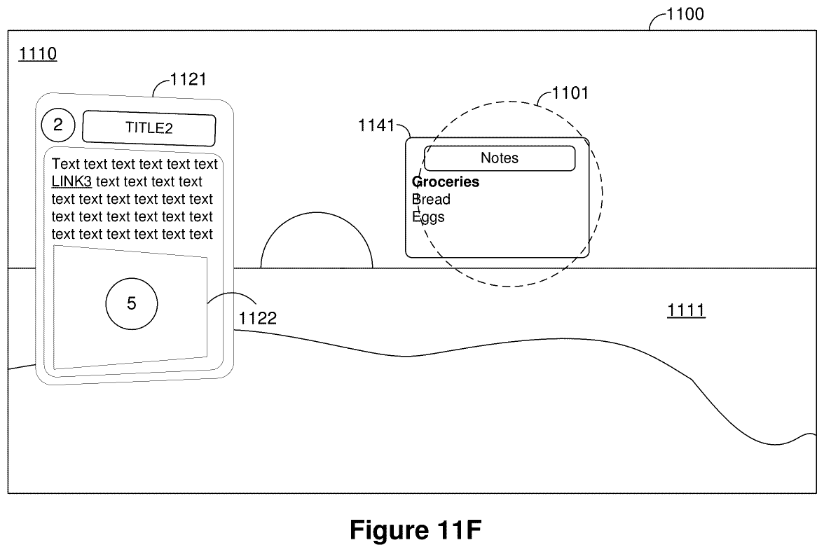

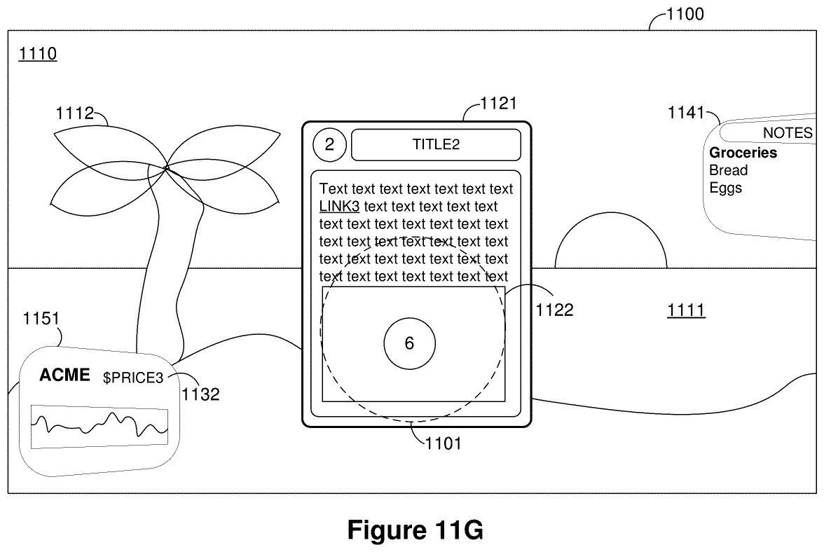

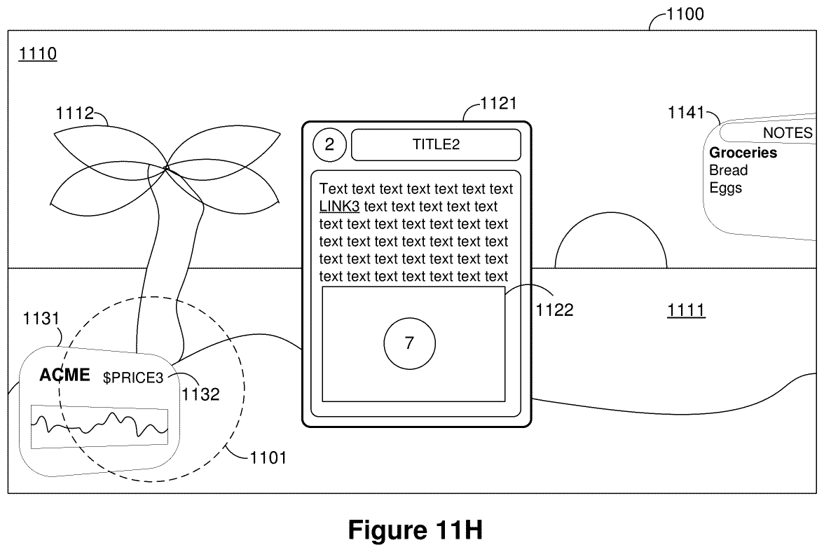

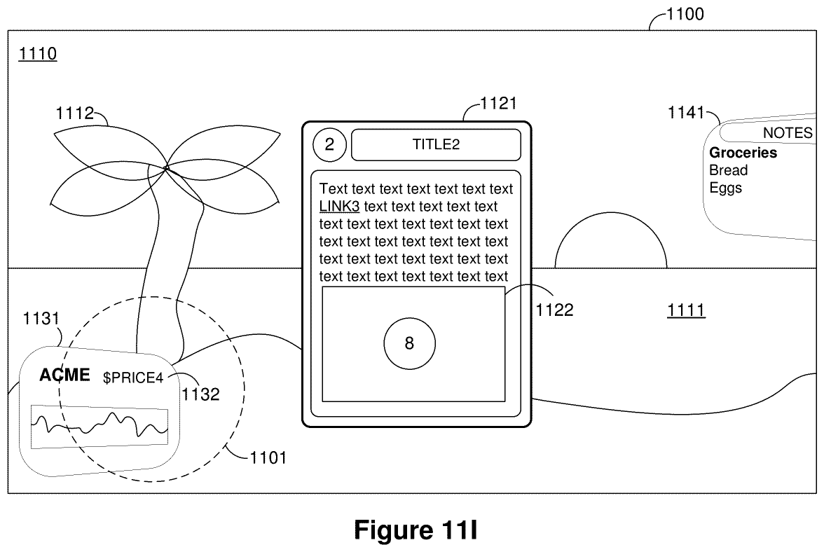

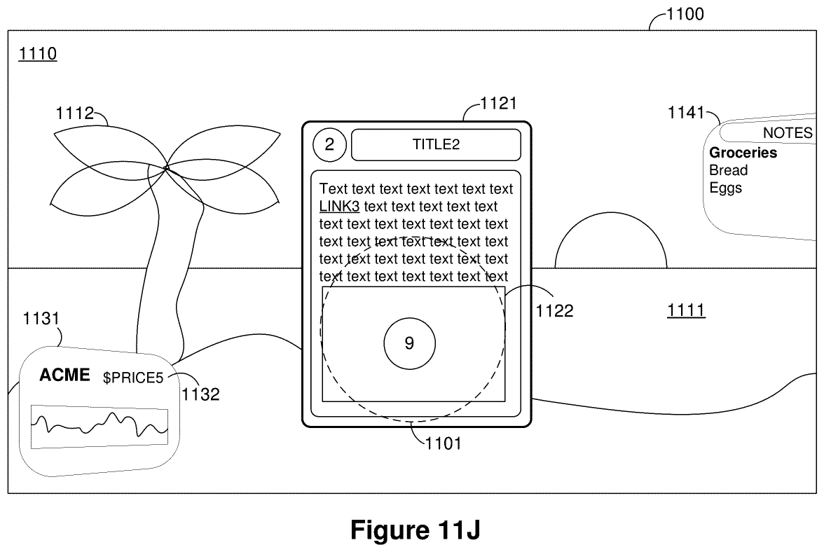

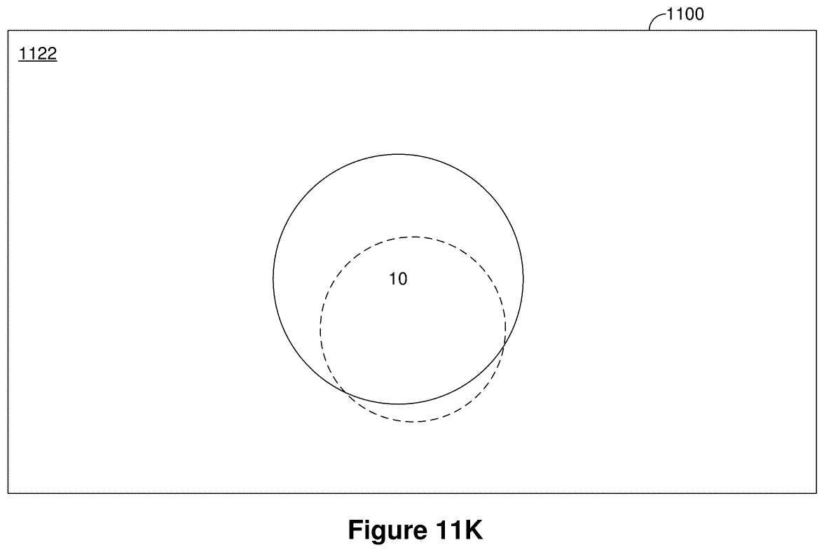

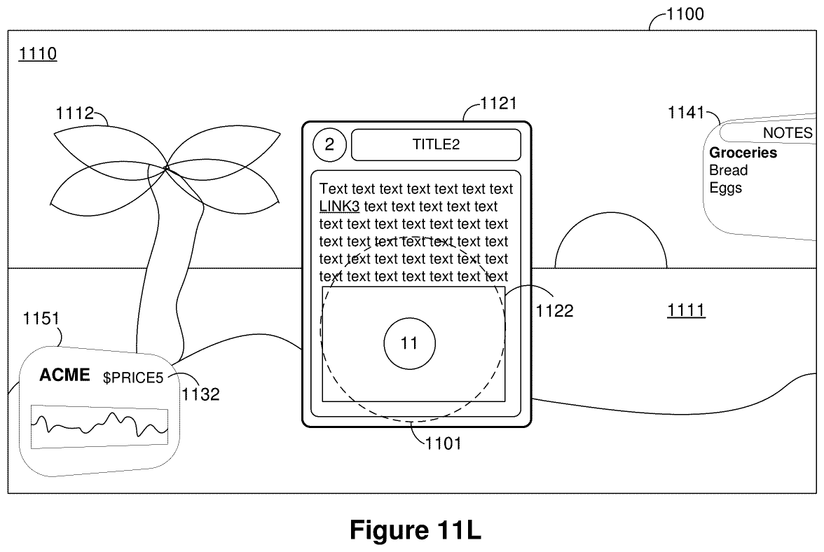

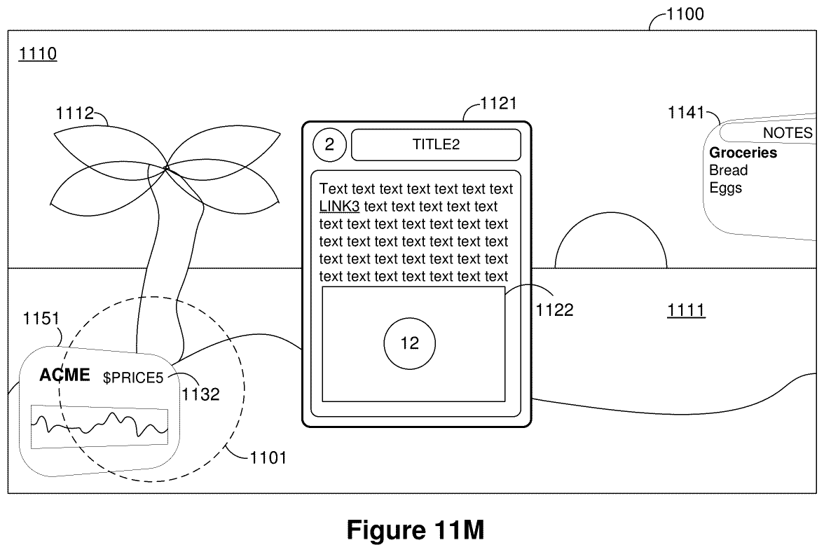

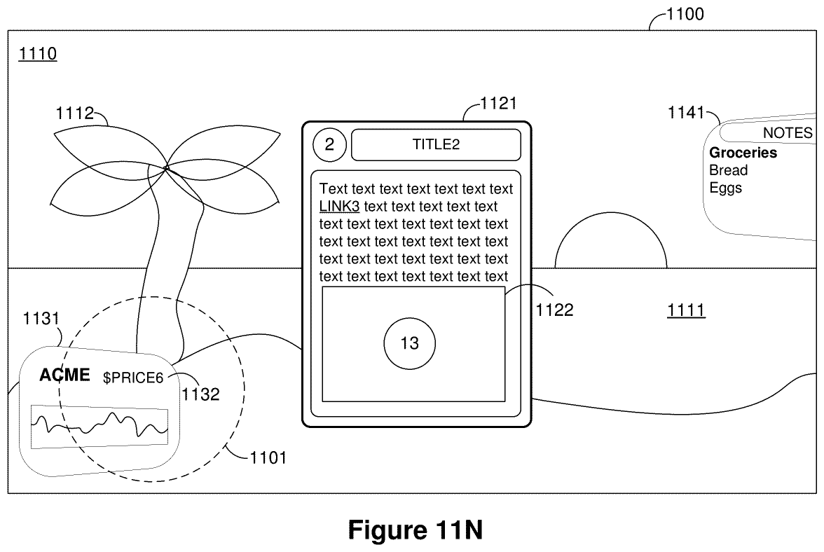

FIGS. 11A-11N illustrate an XR environment 1100 as presented at least partially by the display of a device. FIGS. 11A-11N illustrate the XR environment 1100 during a series of time periods. In various implementations, each time period is an instant, a fraction of a second, a few seconds, a few hours, a few days, or any length of time. For illustrative purposes, FIGS. 11A-11N illustrate a fovea 1101 surrounding the gaze of a user. In various implementations, the fovea 1101 is not displayed by the device.

The XR environment 1100 includes a plurality of virtual objects respectively associated with a plurality of applications. The XR environment 1100 includes a virtual background 1100 presented by a background application. The virtual background 1100 includes a virtual ocean 1111 and a virtual tree 1112. The XR environment 1100 includes a virtual web browser window 1121 presented by a web browser application. The virtual web browser window 1121 displays a webpage including an embedded video 1122. The XR environment 1100 includes a virtual stock tracker window 1131 presented by a stock tracker application. The virtual stock tracker window 1131 displays a price 1132 of a share of a particular stock. The XR environment 1100 includes a virtual notes window 1141 presented by a notes application.

FIG. 11A illustrates the XR environment 1100 during a first time period. Before the first time period, the background application, web browser application, stock tracker application, and notes application are loaded into the memory of the device.

During the first time period, based on data generated by the web browser application, the virtual web browser window 1121 displays the webpage with the embedded video 1122 showing a first frame of video content. During the first time period, based on data generated by the stock tracker application, the virtual stock tracker window 1131 displays the price 1132 as a first price.

During the first time period, as indicated by the fovea 1101, the user is reading text of the webpage displayed by the virtual web browser application.

FIG. 11B illustrates the XR environment 1100 during a second time period subsequent to the first time period.

During the second time period, the virtual web browser window 1121 continues to display the webpage with the embedded video 1122 showing the first frame of video content. During the second time period, based on data generated by the stock tracker application, the virtual stock tracker window 1131 displays the price 1132 as a second price.

During the second time period, as indicated by the fovea 1101, the users is looking at the embedded video 1122 in the virtual web browser window 1121. In response to detecting the user looking at the embedded video 1122 (or in response to another user input initiating playback of the embedded video 1122), the device begins to play the embedded video 1122.

FIG. 11C illustrates the XR environment 1100 during a third time period subsequent to the second time period. During the third time period, with playback of the embedded video 1122 initiated, the virtual web browser window 1121 displays the webpage with the embedded video 1122 showing a second frame of the video content. During the third time period, as indicated by the fovea 1101, the user is watching the embedded video 1122.

Playing the embedded video may be computationally intensive. Accordingly, in various implementations, to save power, the device unloads the virtual stock tracker application from memory. For example, between the second time period and the third time period, the device stores a snapshot of the virtual stock tracker window 1131. The device further stores the location of the virtual stock tracker window 1131 in a three-dimensional coordinate system of the XR environment 1100. In particular, the device stores an indication of the space spanned by the virtual stock tracker window 1131, e.g., its position, orientation, and/or size, in the three-dimensional coordinate system of the XR environment 1100.

The device replaces the virtual stock tracker window 1131 with a virtual placeholder 1151. The virtual placeholder 1151 is a virtual object at the stored location with the stored snapshot as a texture. Further, the device unloads the stock tracker application from the memory. Accordingly, during the third time period, the device displays the virtual placeholder 1151 (rather than the virtual stock tracker window 1131).

During the third time period, the virtual placeholder 1151 is at the same location and displays the same information as the virtual stock tracker window 1131 during the second time period. Thus, during the third time period, the virtual placeholder 1151 displays the price 1132 as the second price. In particular, the price 1132 is not updated by the stock tracker application (which has been unloaded from memory) and may not reflect the current price of the share of the particular stock.

FIG. 11D illustrates the XR environment 1100 during a fourth time period subsequent to the third time period. During the fourth time period, the virtual web browser window 1121 displays the webpage with the embedded video 1122 showing a third frame of the video content. During the fourth time period, the virtual placeholder 1151 displays the price 1132 as the second price.

During the fourth time period, as indicated by the fovea 1101, the user is looking at the virtual placeholder 1151.

FIG. 11E illustrates the XR environment 1100 during a fifth time period subsequent to the fourth time period. In response to detecting the user looking at the virtual placeholder 1151, the device reloads the virtual stock tracker application into the memory and replaces the virtual placeholder 1151 with the virtual stock tracker window 1131. Thus, during the fifth time period, the device displays the virtual stock tracker window 1131 (rather than the virtual placeholder 1151). In various implementations, in response to the increased computation to load the virtual stock tracker application, the device takes other measures to reduce power, such as pausing playback of the embedded video 1122, reducing the resolution and/or frame rate of the virtual background 1110, or replacing the virtual notes window 1141 with a placeholder and unloading the notes application from the memory.

During the fifth time period, the virtual stock tracker window 1131 (as updated by the stock tracker application) displays the price 1132 as a third price. During the fifth time period, the virtual web browser window 1121 displays the webpage with the embedded video 1122 displaying a fourth frame of the video content.

FIG. 11F illustrates the XR environment 1100 during a sixth time period subsequent to the fifth time period. Between the fifth time period and the sixth time period, the head of the user has turned to more directly face the virtual notes window 1141. During the sixth time period, as indicated by the fovea 1101, the user is looking at the virtual notes window 1141. During the sixth time period, the virtual web browser window 1121 displays the webpage with the embedded video 1122 displaying a fifth frame of the video content.

During the sixth time period, the virtual stock tracker window 1131 is not within the field-of-view of the user. In various implementations, in response to determining that the virtual stock tracker window 1131 is not within the field-of-view of the user, the device unloads the virtual stock tracker application from memory. For example, during the sixth time period, the device stores a snapshot of the virtual stock tracker window 1131. The device further stores the location of the virtual stock tracker window 1131 in the three-dimensional coordinate system of the XR environment 1100. In particular, the device stores an indication of the space spanned by the virtual stock tracker window 1131, e.g., its position, orientation, and/or size, in a three-dimensional coordinate system of the XR environment 1100.

The device replaces the virtual stock tracker window 1131 with the virtual placeholder 1151 and unloads the stock tracker application from the memory. As noted above, the virtual placeholder 1151 is a virtual object at the stored location with the stored snapshot as a texture. Thus, just as the virtual stock tracker window 1131 was not within the field-of-view of the user during the sixth time period, neither is the virtual placeholder 1151.

FIG. 11G illustrates the XR environment 1100 during a seventh time period subsequent to the sixth time period. Between the sixth time period and the seventh time period, the head of the user has turned back to more directly face the virtual web browser window 1121. During the seventh time period, as indicated by the fovea 1101, the user is looking at the embedded video 1122 in the virtual web browser window 1121. During the seventh time period, the virtual web browser window 1121 displays the webpage with the embedded video 1122 displaying a sixth frame of the video content.

During the seventh time period, the virtual placeholder 1151 is, again, within the field-of-view of the user. During the seventh time period, the virtual placeholder 1151 displays the price 1132 as the third price.

FIG. 11H illustrates the XR environment 1100 during an eighth time period subsequent to the seventh time period. During the eighth time period, the virtual web browser window 1121 displays the webpage with the embedded video 1122 showing a seventh frame of the video content. During the eighth time period, the virtual placeholder 1151 displays the price 1132 as the third price.

During the eighth time period, as indicated by the fovea 1101, the user is looking at the virtual placeholder 1151.

FIG. 11I illustrates the XR environment 1100 during a ninth time period subsequent to the eighth time period. In response to detecting the user looking at the virtual placeholder 1151, the device reloads the virtual stock tracker application into the memory and replaces the virtual placeholder 1151 with the virtual stock tracker window 1131. Thus, during the ninth time period, the device displays the virtual stock tracker window 1131 (rather than the virtual placeholder 1151).

During the ninth time period, the virtual stock tracker window 1131 (as updated by the stock tracker application) displays the price 1132 as a fourth price. During the ninth time period, the virtual web browser window 1121 displays the webpage with the embedded video 1122 displaying an eighth frame of the video content.

FIG. 11J illustrates the XR environment 1100 during a tenth time period subsequent to the ninth time period. During the tenth time period, as indicated by the fovea 1101, the user is looking at the embedded video 1122. During the tenth time period, the virtual web browser window 1121 displays the webpage with the embedded video 1122 displaying a ninth frame of the video content. During the ninth time period, the virtual stock tracker window 1131 (as updated by the stock tracker application) displays the price 1132 as a fifth price.

During the tenth time period, the device receives a user input to enlarge the embedded video 1122. For example, in various implementations, the embedded video 1122 is an immersive video and, in response to selection of the embedded video 1122, the user is immersed in the immersive video.

FIG. 11K illustrates the XR environment 1100 during an eleventh time period subsequent to the tenth time period. During the eleventh time period, the XR environment 1122 includes only the embedded video 1122 as an immersive video experience. In particular, a tenth frame of the video content of the immersive video is displayed. In an immersive video experience, as the head of the user turns, the video is displayed over a wide range of angled, up to, e.g., 360 degrees.

Rendering an immersive video may be computationally intensive and the virtual stock tracker window 1131 is no longer visible to the user. Accordingly, in various implementations, to save power, the device unloads the virtual stock tracker application from memory. For example, between the eleventh time period and the twelfth time period, the device stores a snapshot of the virtual stock tracker window 1131. The device further stores the location of the virtual stock tracker window 1131 in a three-dimensional coordinate system of the XR environment 1100. In particular, the device stores an indication of the space spanned by the virtual stock tracker window 1131, e.g., its position, orientation, and/or size, in the three-dimensional coordinate system of the XR environment 1100.

The device replaces the virtual stock tracker window 1131 with a virtual placeholder 1151 and unloads the stock tracker application from the memory. However, as the embedded video 1122 is displayed, the virtual placeholder 1151 is not displayed.

During the eleventh time period, the device receives a user input to shrink the embedded video 1122.

FIG. 11L illustrates the XR environment 1100 during a twelfth time period subsequent to the eleventh time period. During the twelfth time period, as indicated by the fovea 1101, the user is looking at the embedded video 1122 in the virtual web browser window 1121. During the twelfth time period, the virtual web browser window 1121 displays the webpage with the embedded video 1122 displaying an eleventh frame of the video content.

During the twelfth time period, the virtual placeholder 1151 is, again, displayed. During the twelfth time period, the virtual placeholder 1151 displays the price 1132 as the fifth price.

FIG. 11M illustrates the XR environment 1100 during thirteenth time period subsequent to the twelfth time period. During the thirteenth time period, the virtual web browser window 1121 displays the webpage with the embedded video 1122 showing a twelfth frame of the video content. During the thirteenth time period, the virtual placeholder 1151 displays the price 1132 as the fifth price.

During the thirteenth time period, as indicated by the fovea 1101, the user is looking at the virtual placeholder 1151.

FIG. 11N illustrates the XR environment 1100 during a fourteenth time period subsequent to the thirteenth time period. In response to detecting the user looking at the virtual placeholder 1151, the device reloads the virtual stock tracker application into the memory and replaces the virtual placeholder 1151 with the virtual stock tracker window 1131. Thus, during the fourteenth time period, the device displays the virtual stock tracker window 1131 (rather than the virtual placeholder 1151).

During the fourteenth time period, the virtual stock tracker window 1131 (as updated by the stock tracker application) displays the price 1132 as a sixth price. During the fourteenth time period, the virtual web browser window 1121 displays the webpage with the embedded video 1122 displaying a thirteenth frame of the video content.

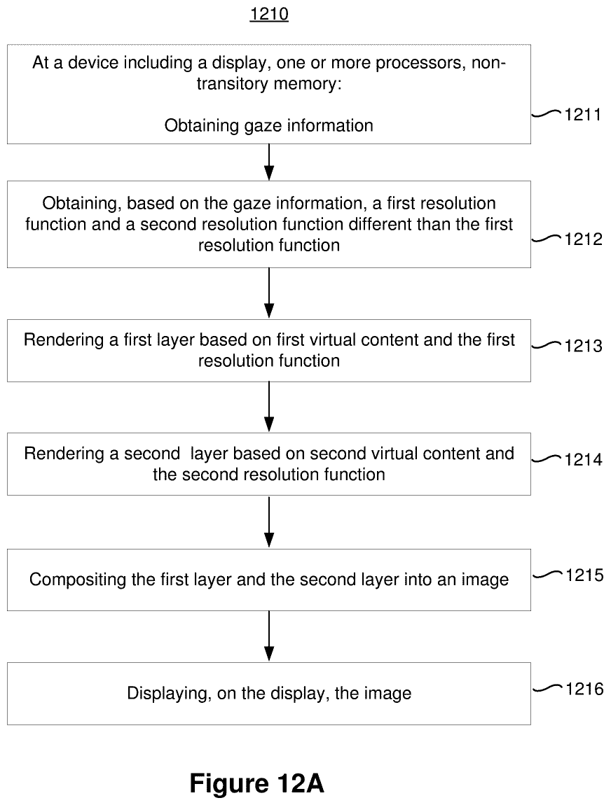

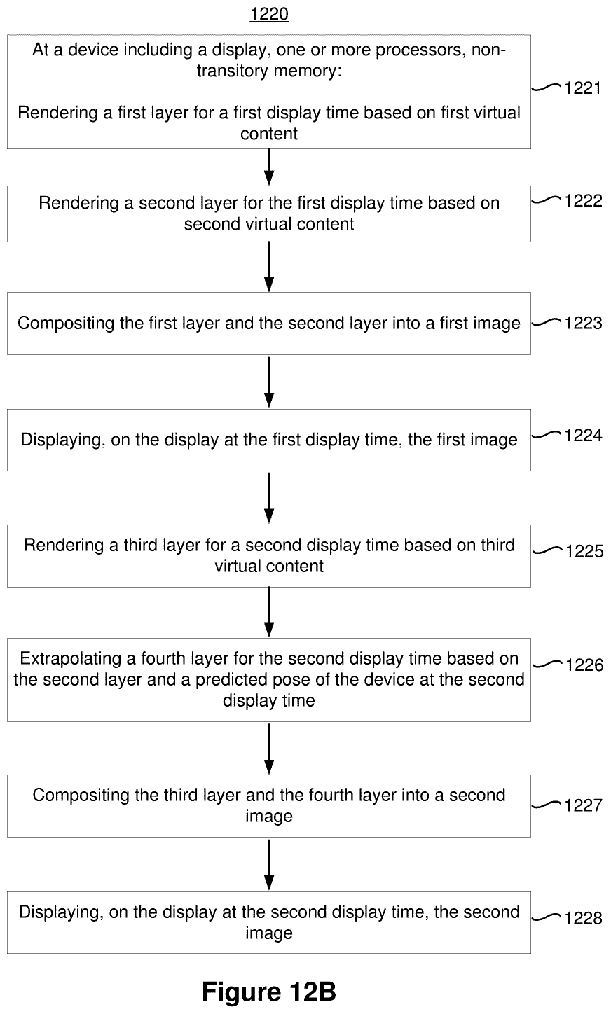

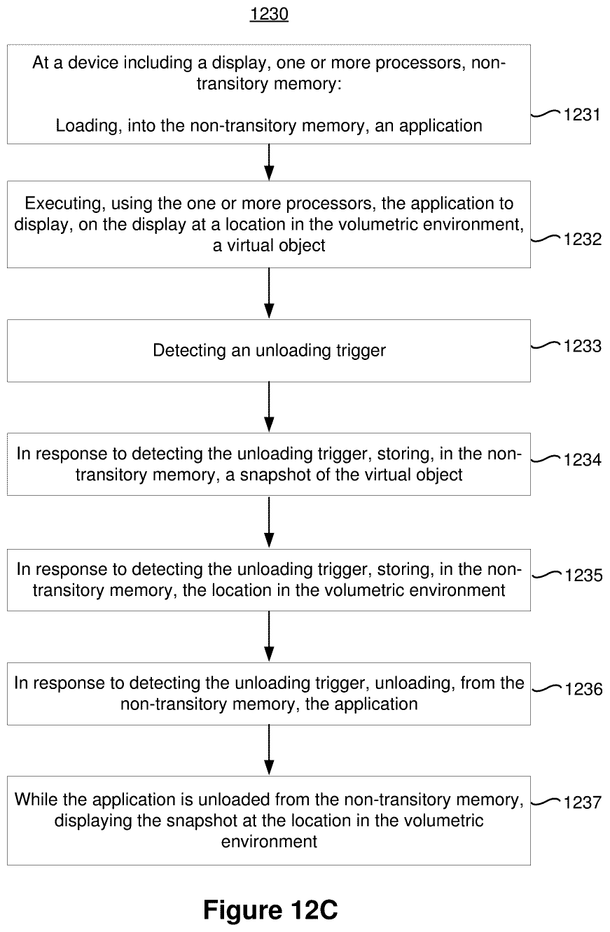

FIG. 12A is a flowchart representation of a method 1210 of displaying an image in accordance with some implementations. In various implementations, the method 1210 is performed by an electronic device, such as the electronic device 120 of FIG. 1, or a portion thereof, such as the XR pipeline 200 of FIG. 2. In various implementations, the method 1210 is performed by a device with a display, one or more processors, and non-transitory memory. In some implementations, the method 1210 is performed by processing logic, including hardware, firmware, software, or a combination thereof. In some implementations, the method 1210 is performed by a processor executing instructions (e.g., code) stored in a non-transitory computer-readable medium (e.g., a memory).

The method 1210 begins, at block 1211, with the device obtaining gaze information. In various implementations, the gaze information includes information about where a user of the device is looking.

The method 1210 continues, in block 1212, with the device obtaining, based on the gaze information, a first resolution function and a second resolution function different than the first resolution function. For example, FIG. 8 illustrates an example foreground resolution function and an example background resolution function different than the example foreground resolution function.

In various implementations, the second resolution function has a lower maximum than the first resolution function. In various implementations, the second resolution function has a lower minimum, faster drop-off, or narrower width than the first resolution function.

In various implementations, the first resolution function and the second resolution function are obtained with a same formula with different parameters. For example, in various implementations, the first resolution function and the second resolution function are obtained using the formula:

$$S ( θ ) = \{ \begin{matrix}{S}_{max} & for \vert θ - {θ}_{g} \vert < {θ}_{f} \\ {S}_{min} + \frac{{S}_{max} - {S}_{min}}{1 + w ( \vert θ - {θ}_{g} - {θ}_{f} \vert )} & for \vert θ - {θ}_{g} \vert \geq {θ}_{f}\end{matrix} .$$

The method 1210 continues, in block 1213, with the device rendering a first layer based on first virtual content and the first resolution function and, in block 1214, with the device rendering a second layer based on second virtual content and the second resolution function. In various implementations, the first layer is a foreground layer and the second layer is a background layer. In various implementations, the first virtual content includes a user interface element of an application. For example, in FIG. 9B, the foreground XR content 920 includes a virtual window 921 of a web browsing application. In various implementations, the second virtual content includes a virtual environment. For example, in FIG. 9A, the background XR content 910 includes a virtual environment of a beach.

In various implementations, at least one of the first resolution function and the second resolution function is based on a power consumption. For example, a combined summation value of the first resolution function and the second resolution function may be constrained by an amount of available processing power. In various implementations, at least one of the first resolution function and the second resolution function is based on a type of the application. For example, when the summation value of the first resolution function and the second resolution function is constrained (either due to power consumption, transmission bandwidth, or other constraints), the device determines how much to decrease the summation value of each the first resolution function and the second resolution function. If the first virtual content includes an application expectant of a high resolution (e.g., a web browsing application, a video player, a photograph editing application, etc.), the summation value of the second resolution function may be decreased more than in the case of an application not expectant of a high resolution (e.g., a music player, a mindfulness application, etc.), in which case the summation value of the first resolution function may be decreased more.

In various implementations, an application developer can define (via an API) a resolution priority of one or more layers of an application. In various implementations, the resolution priority is defined with respect to a baseline resolution priority of a background layer (e.g., a virtual environment). For example, in various implementations, where the baseline resolution priority of the background layer is 0, the application may include a first layer with a resolution priority of 10, a second layer with a resolution priority of 2, and a third layer with a resolution priority of −5. When the summation value of the resolution functions for each layer of the application and the background layer is constrained (either due to power consumption, transmission bandwidth, or other constraints), the device determines how much to decrease the summation value of each the resolution functions as a function of the resolution priorities (e.g., the third layer is decreased more than the background layer, which is decreased more than the second layer, which is decreased more than the first layer).

The method 1210 continues, in block 1215, with the device compositing the first layer and the second layer into an image. In various implementations, compositing the first layer and the second layer includes overlaying the first layer onto the second layer. In various implementations, the first layer and the second layer are processed according to the first resolution function and the second resolution function (or corresponding resolution matrices) before being composited.

The method 1210 continues, in block 1216, with the device displaying, on the display, the image.

In various implementations, the method 1210 further includes rendering a third layer based on the first virtual content and a third resolution function and rendering a fourth layer based on the second virtual content and a fourth resolution function. The method 1210 further includes compositing the third layer and the fourth layer into an additional image and displaying, on the display, the additional image concurrently with the image. In various implementations, the first layer and the third layer correspond to a left foreground layer and a right foreground layer, and the second layer and the fourth layer correspond to a left background layer and a right background layer. Thus, the image is displayed to a left eye of the user and the additional image is displayed to a right eye of the user.

In various implementations, the third resolution function and the fourth resolution function are a common resolution function. For example, in various implementations, the common resolution function is the first resolution function. Thus, in various implementations, binocular variance is only applied to one layer. In various implementations, the third resolution function and the fourth resolution function are different resolution functions. For example, in various implementations, a difference between a maximum of the first resolution function and a maximum of the second resolution function is different than a difference between a maximum of the third resolution function and a maximum of the fourth resolution function. Thus, in various implementations, differing binocular variance is applied to each layer.

In various implementations, the method 1210 includes rendering a third layer based on third virtual content and extrapolating a fourth layer based on the second layer. The method 1210 includes compositing the third layer and the fourth layer into an additional image and displaying, on the display after displaying the image, the additional image. Thus, in various implementations, the foreground layer and the background layer are rendered at different frame rates as will be described in more detail below with respect to FIG. 12B.

FIG. 12B is a flowchart representation of a method 1220 of displaying a sequence of images in accordance with some implementations. In various implementations, the method 1220 is performed by an electronic device, such as the electronic device 120 of FIG. 1, or a portion thereof, such as the XR pipeline 200 of FIG. 2. In various implementations, the method 1220 is performed by a device with a display, one or more processors, and non-transitory memory. In some implementations, the method 1220 is performed by processing logic, including hardware, firmware, software, or a combination thereof. In some implementations, the method 1220 is performed by a processor executing instructions (e.g., code) stored in a non-transitory computer-readable medium (e.g., a memory).

The method 1220 begins, at block 1221, with the device rendering a first layer for a first display time based on virtual content and, in block 1222, with the device rendering a second layer for the first display time based on second virtual content. In various implementations, the first layer and the second layer are rendered as described above in FIG. 12A. Thus, in various implementations, rendering the first layer is based on a first resolution function and rendering the second layer is based on a second resolution function different than the first resolution function. In various implementations, rendering the first layer and rendering the second layer is based on a common resolution function.

The method 1220 continues, in block 1223, with the device compositing the first layer and the second layer into a first image. In various implementations, compositing the first layer and the second layer includes overlaying the first layer onto the second layer. In various implementations, the first layer and the second layer are processed according to a first resolution function and a second resolution function (or corresponding resolution matrices) before being composited.

The method 1220 continues, in block 1224, with the device displaying, on the display, on the display at the first display time, the first image.

The method 1220 continues, in block 1225, with the device rendering a third layer for a second display time based on third virtual content and, in block 1226, extrapolating a fourth layer for the second display time based on the second layer and a predicted pose of the device at the second display time. In various implementations, extrapolating the fourth layer includes performing a homographic transform. In various implementations, extrapolating the fourth layer includes determining, for a plurality of pixels of the fourth layer, corresponding pixel locations of the second layer. In various implementations, extrapolating at least a portion of the fourth layer is based on a single depth. In various implementations, extrapolating at least a portion of the fourth layer is based on a plurality of depths.

The method 1220 continues, in block 1227, with the device compositing the third layer and the fourth layer into a second image and, in block 1228, displaying, on the display at the second display time, the second image.

In various implementations, the first layer (and the third layer) is a foreground layer and the second layer (and the fourth layer) is a background layer. In various implementations, the foreground layer includes a user interface element of an application. In various implementations, a rendering frame rate of the background layer is based on a power consumption. For example, a combined frame rate of the foreground layer and the background layer may be constrained by an amount of available processing power. In various implementations, a rendering frame rate of the background layer is based on a type of the application. For example, when the combined frame rate is constrained (either due to power consumption, transmission bandwidth, or other constraints), the device determines how much to decrease the rendering frame rate of each of the foreground layer and the background layer. If the foreground layer includes an application expectant of a high frame rate (e.g., a web browsing application, a video player, a photograph editing application, etc.), the rendering frame rate of the background layer may be decreased more than in the case of an application not expectant of a high resolution (e.g., a music player, a mindfulness application, etc.), in which case the rendering frame rate of the foreground layer may be decreased more.

The rendering frame rate of the background layer is inversely related to the difference in the first display time and a third display time at which the next rendered background layer is displayed. Accordingly, in various implementations, the method 1220 includes rendering a fifth layer for a third display time based on fourth virtual content and rendering a sixth layer for the third display time based on fifth virtual content. The method 1220 further includes compositing the fifth layer and the sixth layer into a third image and displaying, on the display at the third display time, the third image.

In various implementations, both the foreground layer and the background layer are rendered at (different) rendering frame rates less than a display frame rate. Each of the foreground layer and the background layer are extrapolated up to the display frame rate. Thus, in various implementations, the method 1220 includes extrapolating a fifth layer for a third display time based on the third layer and a predicted pose of the device at the third display time and extrapolating a sixth layer for a third display time based on the fourth layer and the predicted pose of the device at the third display time. The method 1220 further includes compositing the fifth layer and the sixth layer into a third image and displaying, on the display at the third display time, the third image.

In various implementations, rendering the second layer and extrapolating the fourth layer includes rendering an intermediate layer for an intermediate time between the first display time and the second display time, extrapolating (backwards) the intermediate layer to the first display time to generate the second layer, and extrapolating (forwards) the intermediate layer to the second display time to generate the fourth layer.

FIG. 12C is a flowchart representation of a method 1230 of unloading an application from memory in accordance with some implementations. In various implementations, the method 1230 is performed by an electronic device, such as the electronic device 120 of FIG. 1, or a portion thereof, such as the XR pipeline 200 of FIG. 2. In various implementations, the method 1230 is performed by a device with a display, one or more processors, and non-transitory memory. In some implementations, the method 1230 is performed by processing logic, including hardware, firmware, software, or a combination thereof. In some implementations, the method 1230 is performed by a processor executing instructions (e.g., code) stored in a non-transitory computer-readable medium (e.g., a memory).

The method 1230 begins, at block 1231, with the device loading, into the non-transitory memory, an application. In various implementations, loading the application includes launching the application or beginning execution of the application.

The method 1230 continues, at block 1232, with the device executing, using the one or more processors, the application to display, on the display at a location in volumetric environment, a virtual object. For example, in FIG. 11A, the web browser application is executing to display the virtual web browser window 1121, the stock tracker application is executing to display the virtual stock tracker window 1131, and the notes application is executing to display the virtual notes window 1141.

In various implementations, the volumetric environment is a three-dimensional environment associated with a three-dimensional coordinate system. In various implementations, the volumetric environment is an XR environment, such as a virtual reality environment or augmented reality environment.

In various implementations, the location in the volumetric environment is defined by one or more sets of three-dimensional coordinates in a three-dimensional coordinate system of the volumetric environment. In various implementations, the location defines an area of a space defined by the three-dimensional coordinate system of the volumetric environment.

The method 1230 continues, at block 1233, with the device detecting an unloading trigger. In various implementations, the device detects an unloading trigger for a particular application and, as described below in block 1236, unloads the application from memory. In various implementations, detecting the unloading trigger includes determining (or deciding) to unload the application from memory.

In various implementations, detecting the unloading trigger is based on an amount of available processing power. Thus, in various implementations, detecting the unloading trigger includes determining an amount of available processing power. For example, in various implementations, when an amount of available processing power is below a threshold, the device detects an unloading trigger for one or more applications to increase the amount of available processing power, e.g., to execute another computationally intensive application. For example, in FIG. 11B, in order to play the embedded video 1122, the device unloads the stock tracker application from memory. In various implementations, the amount of available processing power is based on a heat generated by the one or more processors of the device.

In various implementations, detecting the unloading trigger is based on the visibility of the virtual object. Thus, in various implementations, detecting the unloading trigger includes determining that the virtual object is not displayed. In various implementations, determining that that the virtual object is not displayed includes determining that the virtual object is outside a field-of-view displayed on the display. For example, in FIG. 11F, because the virtual stock tracker window 1131 is not within the field-of-view, the device unloads the stock tracker application from memory. In various implementations, determining that the virtual object is not displayed includes determining that the virtual object is occluded by another virtual object. For example, in FIG. 11K, because the virtual stock tracker window 1131 is occluded by the embedded video 1122 being displayed as an immersive experience, the device unloads the stock tracker application from memory.

In various implementations, detecting the unloading trigger is based on a focus of a user. Thus, in various implementations, detecting the unloading trigger includes determining a focus of a user. In various implementations, determining the focus of the user is based on a gaze of a user. In various implementations, determining the focus of the user is based on user interaction. For example, in various implementations, when focus of the user is directed to an application, other applications may be unloaded from memory.

In various implementations, detecting the unloading trigger is based on a priority of the application. Thus, in various implementations, detecting the unloading trigger includes determining a priority of the application. In various implementations, different applications have different intrinsic unloading priorities. In various implementations, determining the priority of the application is based on an update rate of the application. For example, applications with a lower update rate are more likely to be unloaded than applications with a higher update rate. For example, an application updated in response to user interaction (e.g., a notes application) may be more likely to be unloaded than an application that is updated periodically (e.g., once per minute such as a stock tracker application) which may be more likely to be unloaded than an application that is continuously updated (e.g., 30 or 60 times a second such as a video player application). In various implementations, the priority of an application is dynamic. For example, a web browser application may have a first priority when displaying static images and having a second (lower) priority when displaying video.

The method 1230 continues, in block 1234, with the device, in response to detecting the unloading trigger, storing, in the non-transitory memory, a snapshot of the virtual object. In various implementations, the snapshot is an image. In various implementations, the image is a matrix of pixels, each having a respective pixel value. In various implementations, the image is an RGB, RGBA, or YCbCr image.

In various implementations, the image is a texture map. Thus, in various implementations, storing the snapshot of the virtual object includes storing a texture map of the virtual object.

In various implementations, the virtual object is a two-dimensional object, such as a window of an application. Thus, in various implementations, storing the snapshot of the virtual object includes storing an image of the virtual object from a virtual camera pose in the volumetric environment, e.g., a position in front of the two-dimensional object and an orientation facing the virtual object.

In various implementations, the virtual object is a three-dimensional object, such as a virtual globe. Thus, in various implementations, storing the snapshot of the virtual object includes storing multiple images of the virtual object from multiple virtual camera poses in the volumetric environment, e.g., at positions around the virtual object and orientations facing the virtual object.

The method 1230 continues, in block 1235, with the device, in response to detecting the unloading trigger, storing, in the non-transitory memory, the location in the volumetric environment.

The method 1230 continues, in block 1236, with the device, in response to detecting the unloading trigger, unloading, from the non-transitory memory, the application. In various implementations, unloading the application includes closing the application or ceasing the execute the application.

The method 1230 continues, in block 1237, with the device, while the application is unloaded from the non-transitory memory, displaying the snapshot at the location in the volumetric environment. In various implementations, the virtual object is a two-dimensional object and displaying the snapshot at the location in the volumetric environment includes displaying a two-dimensional virtual placeholder object having the same shape, position, orientation, and/or size as the virtual object using the snapshot as a texture map. For example, in FIG. 11C, the device displays the virtual placeholder 1151 at the location previously occupied by the virtual stock tracker window 1131 with the image of the virtual stock tracker window 1131 as a texture map.

In various implementations, the virtual object is a three-dimensional object and displaying the snapshot at the location in the volumetric environment includes displaying a three-dimensional virtual placeholder object having the same shape, position, orientation, and/or size as the virtual object using the snapshot as a texture map. In various implementations, the virtual object is a three-dimensional object and displaying the snapshot at the location in the volumetric environment includes displaying a two-dimensional virtual placeholder object having the same shape, position, orientation, and/or size as a projection of the virtual object using the snapshot as a texture map. In various implementations, the virtual object is a three-dimensional object and displaying the snapshot at the location in the volumetric environment includes displaying, to a left eye of the user, a first snapshot of the virtual object and, to a right eye of the user, a second snapshot of the virtual object. In various implementations, the first snapshot and the second snapshot are selected from multiple images of the virtual object from multiple virtual camera poses in the volumetric environment. In particular, in various implementations, the first snapshot and the second snapshot are selected as those from the multiple virtual camera poses that are closest to the left eye of the user and the right eye of the user.

In various implementations, the method 1230 includes detecting a reloading trigger. In various implementations, detecting the reloading trigger is based on the various factors described above with respect to the unloading trigger. In various implementations, the method 1230 includes, in response to detecting the reloading trigger, reloading, into the non-transitory memory, the application. In various implementations, reloading the application includes relaunching the application or restarting execution of the application. In various implementations, the method 1230 includes, in response to detecting the reloading trigger, executing, using the one or more processors, the application to display, on the display at the location in the volumetric environment, the virtual object. For example, in response to the user looking at the virtual placeholder object 1151 in FIG. 11D, the device displays, in FIG. 11E, the virtual stock tracker window 1131. In various implementations, the method 1230 includes, in response to detecting the reloading trigger, ceasing to display the snapshot at the location in the volumetric environment.

FIG. 13 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 1302 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 1306, one or more communication interfaces 1308 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 1310, a memory 1320, and one or more communication buses 1304 for interconnecting these and various other components.

In some implementations, the one or more communication buses 1304 include circuitry that interconnects and controls communications between system components. In some implementations, the one or more I/O devices 1306 include at least one of a keyboard, a mouse, a touchpad, a joystick, one or more microphones, one or more speakers, one or more image sensors, one or more displays, and/or the like.

The memory 1320 includes high-speed random-access memory, such as dynamic random-access memory (DRAM), static random-access memory (SRAM), double-data-rate random-access memory (DDR RAM), or other random-access solid-state memory devices. In some implementations, the memory 1320 includes non-volatile memory, such as one or more magnetic disk storage devices, optical disk storage devices, flash memory devices, or other non-volatile solid-state storage devices. The memory 1320 optionally includes one or more storage devices remotely located from the one or more processing units 1302. The memory 1320 comprises a non-transitory computer readable storage medium. In some implementations, the memory 1320 or the non-transitory computer readable storage medium of the memory 1320 stores the following programs, modules and data structures, or a subset thereof including an optional operating system 1330 and an XR experience module 1340.

The operating system 1330 includes procedures for handling various basic system services and for performing hardware dependent tasks. In some implementations, the XR experience module 1340 is configured to manage and coordinate one or more XR experiences for one or more users (e.g., a single XR experience for one or more users, or multiple XR experiences for respective groups of one or more users). To that end, in various implementations, the XR experience module 1340 includes a data obtaining unit 1342, a tracking unit 1344, a coordination unit 1346, and a data transmitting unit 1348.

In some implementations, the data obtaining unit 1342 is configured to obtain data (e.g., presentation data, interaction data, sensor data, location data, etc.) from at least the electronic device 120 of FIG. 1. To that end, in various implementations, the data obtaining unit 1342 includes instructions and/or logic therefor, and heuristics and metadata therefor.

In some implementations, the tracking unit 1344 is configured to map the physical environment 105 and to track the position/location of at least the electronic device 120 with respect to the physical environment 105 of FIG. 1. To that end, in various implementations, the tracking unit 1344 includes instructions and/or logic therefor, and heuristics and metadata therefor.

In some implementations, the coordination unit 1346 is configured to manage and coordinate the XR experience presented to the user by the electronic device 120. To that end, in various implementations, the coordination unit 1346 includes instructions and/or logic therefor, and heuristics and metadata therefor.

In some implementations, the data transmitting unit 1348 is configured to transmit data (e.g., presentation data, location data, etc.) to at least the electronic device 120. To that end, in various implementations, the data transmitting unit 1348 includes instructions and/or logic therefor, and heuristics and metadata therefor.

Although the data obtaining unit 1342, the tracking unit 1344, the coordination unit 1346, and the data transmitting unit 1348 are shown as residing on a single device (e.g., the controller 110), it should be understood that in other implementations, any combination of the data obtaining unit 1342, the tracking unit 1344, the coordination unit 1346, and the data transmitting unit 1348 may be located in separate computing devices.

Moreover, FIG. 13 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 13 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 14 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 1402 (e.g., microprocessors, ASICs, FPGAs, GPUs, CPUs, processing cores, and/or the like), one or more input/output (I/O) devices and sensors 1406, one or more communication interfaces 1408 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 1410, one or more XR displays 1412, one or more optional interior- and/or exterior-facing image sensors 1414, a memory 1420, and one or more communication buses 1404 for interconnecting these and various other components.

In some implementations, the one or more communication buses 1404 include circuitry that interconnects and controls communications between system components. In some implementations, the one or more I/O devices and sensors 1406 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 1412 are configured to provide the XR experience to the user. In some implementations, the one or more XR displays 1412 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 1412 correspond to diffractive, reflective, polarized, holographic, etc. waveguide displays. For example, the electronic device 120 includes a single XR display. In another example, the electronic device includes an XR display for each eye of the user. In some implementations, the one or more XR displays 1412 are capable of presenting MR and VR content.

In some implementations, the one or more image sensors 1414 are configured to obtain image data that corresponds to at least a portion of the face of the user that includes the eyes of the user (any may be referred to as an eye-tracking camera). In some implementations, the one or more image sensors 1414 are configured to be forward-facing so as to obtain image data that corresponds to the physical environment as would be viewed by the user if the electronic device 120 was not present (and may be referred to as a scene camera). The one or more optional image sensors 1414 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 1420 includes high-speed random-access memory, such as DRAM, SRAM, DDR RAM, or other random-access solid-state memory devices. In some implementations, the memory 1420 includes non-volatile memory, such as one or more magnetic disk storage devices, optical disk storage devices, flash memory devices, or other non-volatile solid-state storage devices. The memory 1420 optionally includes one or more storage devices remotely located from the one or more processing units 1402. The memory 1420 comprises a non-transitory computer readable storage medium. In some implementations, the memory 1420 or the non-transitory computer readable storage medium of the memory 1420 stores the following programs, modules and data structures, or a subset thereof including an optional operating system 1430 and an XR presentation module 1440.

The operating system 1430 includes procedures for handling various basic system services and for performing hardware dependent tasks. In some implementations, the XR presentation module 1440 is configured to present XR content to the user via the one or more XR displays 1412. To that end, in various implementations, the XR presentation module 1440 includes a data obtaining unit 1442, a layer rendering unit 1444, an XR presenting unit 1446, and a data transmitting unit 1448.

In some implementations, the data obtaining unit 1442 is configured to obtain data (e.g., presentation data, interaction data, sensor data, location data, etc.) from at least the controller 110 of FIG. 1. To that end, in various implementations, the data obtaining unit 1442 includes instructions and/or logic therefor, and heuristics and metadata therefor.

In some implementations, the layer rendering unit 1444 is configured to render different layers of content using different parameters, such as different resolution functions and/or different frame rates. To that end, in various implementations, the layer rendering unit 1444 includes instructions and/or logic therefor, and heuristics and metadata therefor.

In some implementations, the XR presenting unit 1446 is configured to display the transformed image via the one or more XR displays 1412. To that end, in various implementations, the XR presenting unit 1446 includes instructions and/or logic therefor, and heuristics and metadata therefor.

In some implementations, the data transmitting unit 1448 is configured to transmit data (e.g., presentation data, location data, etc.) to at least the controller 110. In some implementations, the data transmitting unit 1448 is configured to transmit authentication credentials to the electronic device. To that end, in various implementations, the data transmitting unit 1448 includes instructions and/or logic therefor, and heuristics and metadata therefor.

Although the data obtaining unit 1442, the layer rendering unit 1444, the XR presenting unit 1446, and the data transmitting unit 1448 are shown as residing on a single device (e.g., the electronic device 120), it should be understood that in other implementations, any combination of the data obtaining unit 1442, the layer rendering unit 1444, the XR presenting unit 1446, and the data transmitting unit 1448 may be located in separate computing devices.

Moreover, FIG. 14 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 14 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including a display, one or more processors, and non-transitory memory:
obtaining gaze information;
obtaining, based on the gaze information, a first resolution function and a second resolution function different than the first resolution function;
rendering a first layer based on first virtual content and the first resolution function;
rendering a second layer based on second virtual content and the second resolution function;
compositing the first layer and the second layer into an image; and
displaying, on the display, the image.

2. The method of claim 1, wherein the second resolution function has a lower maximum than the first resolution function.

3. The method of claim 1, wherein the second resolution function has a lower minimum, faster drop-off, or narrower width than the first resolution function.

4. The method of claim 1, wherein the first resolution function and the second resolution function are obtained with a same formula with different parameters.

5. The method of claim 1, wherein the first layer is a foreground layer and the second layer is a background layer.

6. The method of claim 1, wherein the first virtual content includes a user interface element of an application.

7. The method of claim 6, wherein at least one of the first resolution function and the second resolution function is based on a type of the application.

8. The method of claim 6, wherein the second virtual content includes a virtual environment.

9. The method of claim 1, wherein at least one of the first resolution function and the second resolution function is based on a power consumption.

10. The method of claim 1, further comprising:
rendering a third layer based on the first virtual content and a third resolution function;
rendering a fourth layer based on the second virtual content and a fourth resolution function;
compositing the third layer and the fourth layer into an additional image; and
displaying, on the display, the additional image concurrently with the image.

11. The method of claim 10, wherein the third resolution function and the fourth resolution function are a common resolution function.

12. The method of claim 10, wherein the third resolution function and the fourth resolution function are different resolution functions.

13. The method of claim 12, wherein a difference between a maximum of the first resolution function and a maximum of the second resolution function is different than a difference between a maximum of the third resolution function and a maximum of the fourth resolution function.

14. The method of claim 1, further comprising:
rendering a third layer based on third virtual content;
extrapolating a fourth layer based on the second layer;
compositing the third layer and the fourth layer into an additional image; and
displaying, on the display after displaying the image, the additional image.

15. A device comprising:
a display;
a non-transitory memory; and
one or more processors to:
obtain gaze information;
obtain, based on the gaze information, a first resolution function and a second resolution function different than the first resolution function;
render a first layer based on first virtual content and the first resolution function;
render a second layer based on second virtual content and the second resolution function;
composite the first layer and the second layer into an image; and
display, on the display, the image.

16. The device of claim 15, wherein the second resolution function has a lower maximum than the first resolution function.

17. The device of claim 15, wherein the second resolution function has a lower minimum, faster drop-off, or narrower width than the first resolution function.

18. The device of claim 15, wherein the first resolution function and the second resolution function are obtained with a same formula with different parameters.

19. The device of claim 15, wherein at least one of the first resolution function and the second resolution function is based on a power consumption.

20. A non-transitory memory storing one or more programs, which, when executed by one or more processors of a device including a display, cause the device to:
obtain gaze information;
obtain, based on the gaze information, a first resolution function and a second resolution function different than the first resolution function;
render a first layer based on first virtual content and the first resolution function;
render a second layer based on second virtual content and the second resolution function;
composite the first layer and the second layer into an image; and
display, on the display, the image.
